(19) United States
(12) Patent Application Publication
(10) Pub. No.: US 2026/0003112 A1
(43) Pub. Date: Jan. 1, 2026

(54) LIGHT ABSORPTION ANISOTROPIC FILM, LAMINATE, COMPOSITE LENS, AND VIRTUAL REALITY DISPLAY APPARATUS

(71) Applicant: FUJIFILM Corporation, Tokyo (JP)

(72) Inventor: Toshikazu SUMI, Kanagawa (JP)

(73) Assignee: FUJIFILM Corporation, Tokyo (JP)

(21) Appl. No.: 19/317,927

(22) Filed: Sep. 3, 2025

Related U.S. Application Data
(63) Continuation of application No. PCT/JP2024/007019, filed on Feb. 27, 2024.

(30) Foreign Application Priority Data
Mar. 28, 2023 (JP) 2023-051141

(51) Int. Cl. G02B 5/30; G01M 11/02; G02B 5/24

(52) U.S. Cl. CPC G02B 5/3016; G01M 11/0285; G02B 5/24

(57) ABSTRACT

A light absorption anisotropic film in which occurrence of ghost is suppressed in a case of being applied to a pancake lens-type virtual reality display apparatus. The light absorption anisotropic film of the present invention is a light absorption anisotropic film having a curved surface portion, in which a transmittance measured by a predetermined procedure satisfies the expression ΔT₁=|T₁₁−T₁₂|≤2.5% (1).

### CROSS-REFERENCE TO RELATED APPLICATIONS

This application is a Continuation of PCT International Application No. PCT/JP2024/007019 filed on Feb. 27, 2024, which was published under PCT Article 21(2) in Japanese, and which claims priority under 35 U.S.C. § 119(a) to Japanese Patent Application No. 2023-051141 filed on Mar. 28, 2023. The above applications are hereby expressly incorporated by reference, in their entirety, into the present application.

### BACKGROUND OF THE INVENTION

### 1. Field of the Invention

The present invention relates to a light absorption anisotropic film, a laminate, a composite lens, and a virtual reality display apparatus.

### 2. Description of the Related Art

A virtual reality display apparatus is a display device which can provide a realistic effect as if entering a virtual world by wearing a dedicated headset on a head and visually recognizing a video displayed through a lens.

In addition, in the virtual reality display apparatus, a configuration called a pancake lens has been proposed, the lens configuration including an image display device, a reflective type polarizer, a half mirror, a retardation layer, and the like, in which the entire thickness of a headset is reduced by reciprocating rays emitted from the image display device between the reflective type polarizer and the half mirror.

WO2022/075475A discloses a laminated optical film including a reflective type circular polarizer, a retardation layer which converts circularly polarized light into linearly polarized light, and a linear polarizer in this order, and discloses that this laminated optical film can be applied to the pancake lens-type virtual reality display apparatus.

### SUMMARY OF THE INVENTION

As disclosed in WO2022/075475A, in a case where the laminated optical film is applied to the virtual reality display apparatus, the laminated optical film may be formed into a non-planar shape such as a curved surface shape, according to the shape of the lens or the like.

The present inventor has found that, in a case where the laminated optical film as disclosed in WO2022/075475A is formed in a curved surface shape and applied to the pancake lens-type virtual reality display apparatus, occurrence of ghost is observed, and it is necessary to suppress the occurrence of the ghost.

In view of the above-described circumstances, an object of the present invention is to provide a light absorption anisotropic film in which occurrence of ghost is suppressed in a case of being applied to a pancake lens-type virtual reality display apparatus.

Another object of the present invention is to provide a laminate, a composite lens, and a virtual reality display apparatus.

As a result of intensive studies to achieve the above-described object, the present inventors have found that, in a case where a light absorption anisotropic film in which an absolute value of a difference in transmittance at a plurality of specific positions is 2.5% or less is applied to a pancake lens-type virtual reality display apparatus, the occurrence of ghost can be suppressed, and thus completed the present invention.

That is, the present inventors have found that the above-described object can be achieved by employing the following configurations.

[1] A light absorption anisotropic film having a curved surface portion,
in which a transmittance measured by the following procedure satisfies an expression (1) described later,
the procedure:
1: the light absorption anisotropic film is orthographically projected to specify a maximum projection image having a maximum area,
2: a circle X having a minimum area, including all maximum projection images of the light absorption anisotropic film, is drawn as a circle having a center at a centroid of the maximum projection image of the light absorption anisotropic film,
3: a circle Y having a radius of ½ of a radius of the circle X is drawn as a circle having a center at the centroid of the maximum projection image of the light absorption anisotropic film,
4: a transmittance T₁₁ at an intersection G between a line which passes through the centroid of the maximum projection image of the light absorption anisotropic film and extends in a normal direction of the maximum projection image and the light absorption anisotropic film is measured,
5: transmittances are measured at each intersection between each line which passes through any four points on the circle Y and extends in the normal direction of the maximum projection image and the light absorption anisotropic film, and among these transmittances, a transmittance T₁₂ at which an absolute value of a difference with the transmittance T₁₁ is maximum is specified; where a point at which the transmittance T₁₂ in the light absorption anisotropic film is measured is denoted by an intersection A.
[2] The light absorption anisotropic film according to [1],
in which, with regard to the transmittance at the intersection G, in a case where a transmittance before heating at 120° C. for 10 minutes is denoted by T₂₁ and a transmittance after the heating is denoted by T₂₂, an expression (2) described later is satisfied.
[3] The light absorption anisotropic film according to [1] or [2],
in which, in a case where a brightness at the intersection G is denoted by L₁₁* and a chromaticity is denoted by a₁₁* and b₁₁*, and a brightness at the intersection A is denoted by L₁₂* and a chromaticity is denoted by a₁₂* and biz*, an expression (3) described later is satisfied.
[4] The light absorption anisotropic film according to any one of [1] to [3],
in which the light absorption anisotropic film contains a dichroic substance.
[5] The light absorption anisotropic film according to [4],
in which at least a part of the dichroic substance forms an arrangement structure.
[6] The light absorption anisotropic film according to [5],
in which, in a case where 100 arrangement structures present in a cross section of the light absorption anisotropic film observed with a scanning transmission electron microscope are selected, the number of arrangement structures in which a length of a major axis is less than 50 nm is 30 or less.
[7] The light absorption anisotropic film according to any one of [4] to [6],
in which a content of the dichroic substance is 230 mg/cm³ or more.
[8] The light absorption anisotropic film according to any one of [1] to [7],
in which the light absorption anisotropic film is a film obtained by fixing an alignment state of a liquid crystal composition containing a liquid crystal compound, and
a LogP value of the liquid crystal compound is 6 or less,
provided that, in a case where the liquid crystal composition contains a plurality of kinds of liquid crystal compounds, the LogP value of the liquid crystal compound refers to a largest LogP value among LogP values of the plurality of kinds of liquid crystal compounds.
[9]A laminate comprising:
the light absorption anisotropic film according to any one of [1] to [8].
[10] The laminate according to [9],
in which the laminate includes the light absorption anisotropic film, a retardation layer, and a reflective polarizer layer.
[11] A composite lens comprising, in the following order:
the laminate according to [9];
a lens; and
a half mirror.
[12] A virtual reality display apparatus comprising:
the laminate according to [9].

According to the present invention, it is possible to provide a light absorption anisotropic film in which occurrence of ghost is suppressed in a case of being applied to a pancake lens-type virtual reality display apparatus.

According to the present invention, it is possible to provide a laminate, a composite lens, and a virtual reality display apparatus.

### BRIEF DESCRIPTION OF THE DRAWINGS

FIG. 1 is a top view showing an example of a light absorption anisotropic film according to the embodiment of the present invention.

FIG. 2 is a cross-sectional view taken along a line A-A in FIG. 1.

FIG. 3 is a view describing a procedure for measuring a transmittance.

FIG. 4 is a view for describing a procedure for forming a film using a forming die having a concave forming surface.

FIG. 5 is a view for describing a procedure for forming a film using a forming die having a concave forming surface.

FIG. 6 is a top view of the film used for the forming.

FIG. 7 is a view for describing a procedure for forming a film using a forming die having a convex forming surface.

FIG. 8 is a view for describing a procedure for forming a film using a forming die having a convex forming surface.

FIG. 9 is a cross-sectional view showing an example of a laminate according to the embodiment of the present invention.

FIG. 10 is a cross-sectional view showing another example of the laminate according to the embodiment of the present invention.

FIG. 11 is a cross-sectional view showing an example of a composite lens according to the embodiment of the present invention.

FIG. 12 is a view showing an example of a virtual reality display apparatus according to the embodiment of the present invention, and shows an example of a ray of a main image.

### DESCRIPTION OF THE PREFERRED EMBODIMENTS

Hereinafter, the present invention will be described in detail.

The description of the configuration requirements described below may be made based on representative embodiments and specific examples, but the present invention is not limited to such embodiments.

Any numerical range expressed using “to” in the present specification refers to a range including the numerical values before and after the “to” as a lower limit value and an upper limit value, respectively.

In addition, in a range of numerical values described in stages in the present specification, the upper limit value or the lower limit value described in a certain range of numerical values may be replaced with an upper limit value or a lower limit value of the range of numerical values described in other stages. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof. Here, in a case where two or more types of substances are used in combination for each component, the content of the component refers to a total content of the substances used in combination unless otherwise specified.

In addition, in this specification, “(meth)acrylic” is a notation representing “acrylic” or “methacrylic”.

In the present specification, a term “transmittance” refers to an average transmittance in a wavelength range of 380 to 780 nm.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which refractive index is maximized in a plane.

In the present specification, Re(λ) and Rth(λ) respectively represent an in-plane direction retardation at a wavelength λ and a thickness-direction retardation at a wavelength λ. Unless otherwise specified, the wavelength λ is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d (μm)) in AxoScan, a slow axis direction (°), Re(λ)=R0(λ), and Rth(λ)=((nx+ny)/2−nz)×d are calculated.

Although R0(λ) is described as a numerical value calculated by AxoScan, it means Re(λ).

In the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$n x > ny \approx nz \qquad Expression ( A1 )$$

$$ny < nx \approx nz \qquad Expression ( A2 )$$

The symbol “≈” encompasses not only a case where both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of Expression (C1) and the negative C-plate satisfies a relationship of Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where the both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

### [Light Absorption Anisotropic Film]

The light absorption anisotropic film according to the embodiment of the present invention has a curved surface portion, in which a transmittance measured by a procedure described later satisfies an expression (1) described later.

In addition, the light absorption anisotropic film according to the embodiment of the present invention is a film having absorption anisotropy, and it is preferable that the light absorption anisotropic film has absorption anisotropy in an in-plane direction. Among these, the light absorption anisotropic film preferably functions as an absorptive linear polarizer.

### [Curved Surface Portion]

The light absorption anisotropic film according to the embodiment of the present invention has a curved surface portion.

Here, the curved surface portion means a portion having a curved surface shape.

In addition, the curved surface shape means a shape having a curvature of more than 0, and includes a curved surface shape which is a developable surface and a three-dimensional curved surface shape. A curvature radius of the shape having a curvature is preferably 10 mm to 120 mm and more preferably 15 to 90 mm.

The developable surface means a surface which can be developed on a plane without expanding and contracting each portion of the surface, and examples of the curved surface shape which is a developable surface include surfaces corresponding to a cylindrical peripheral surface, an elliptical cylindrical peripheral surface, a conical peripheral surface, an elliptical conical peripheral surface, and the like; and the curved surface shape may be a convex curved surface or a concave curved surface.

The three-dimensional curved surface shape is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational parabolic surface). The three-dimensional curved surface shape may be a convex curved surface or a concave curved surface.

The curved surface shape of the curved surface portion is preferably lens-like.

Examples of the lens-like curved surface shape include a spherical surface shape and a rotational ellipsoid surface shape; and the lens-like curved surface shape may be a convex lens-like shape or a concave lens-like shape.

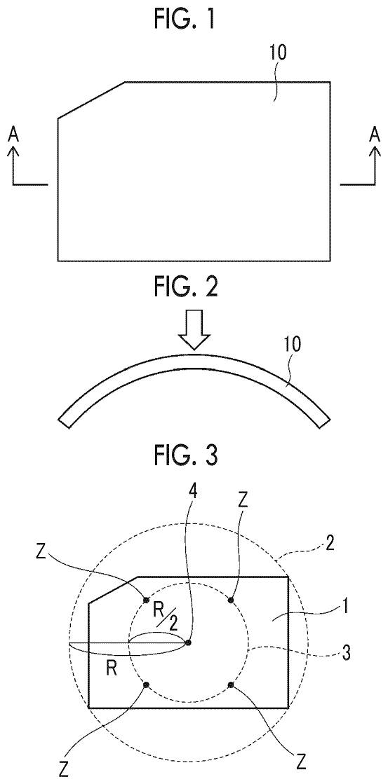

FIG. 1 shows an example of the light absorption anisotropic film according to the embodiment of the present invention.

FIG. 1 is a top view of the light absorption anisotropic film, and FIG. 2 is a cross-sectional view taken along a line A-A of FIG. 1.

As shown in FIGS. 1 and 2, a light absorption anisotropic film 10 has a curved surface shape. More specifically, as shown in FIG. 2, the light absorption anisotropic film 10 has a shape (convex shape) which is convexly curved toward the upper side of the paper plane. That is, the light absorption anisotropic film 10 has a convex shape protruding to one surface side. It can be said that the light absorption anisotropic film 10 has a concave shape in which the other surface side is concave.

In FIG. 1, an aspect in which the shape of the light absorption anisotropic film in a plan view is a pentagon is shown; but the present invention is not limited to this aspect, and the shape of the light absorption anisotropic film in a plan view may be a quadrangle, a circle, or another shape.

### [Transmittance]

In the light absorption anisotropic film according to the embodiment of the present invention, a transmittance measured by the following procedure satisfies the following expression (1).

### Procedure

1: The light absorption anisotropic film is orthographically projected to specify a maximum projection image having a maximum area.
2: A circle X having a minimum area, including all maximum projection images of the light absorption anisotropic film, is drawn as a circle having a center at a centroid of the maximum projection image of the light absorption anisotropic film.
3: A circle Y having a radius of ½ of a radius of the circle X is drawn as a circle having a center at the centroid of the maximum projection image of the light absorption anisotropic film.
4: A transmittance T₁₁ at an intersection G between a line which passes through the centroid of the maximum projection image of the light absorption anisotropic film and extends in a normal direction of the maximum projection image and the light absorption anisotropic film is measured.
5: Transmittances are measured at each intersection between each line which passes through any four points on the circle Y and extends in the normal direction of the maximum projection image and the light absorption anisotropic film, and among these transmittances, a transmittance T₁₂ at which an absolute value of a difference with the transmittance T₁₁ is maximum is specified; here, a point at which the transmittance T₁₂ in the light absorption anisotropic film is measured is denoted by an intersection A.

$$Δ {T}_{1} = \vert {T}_{11} - {T}_{12} \vert \leq 2.5 \% \qquad Expression ( 1 )$$

The procedure for measuring the transmittance will be described with reference to FIG. 3.

The maximum projection image in the procedure 1 is a projection image having the largest area among projection images obtained by orthographically projecting the light absorption anisotropic film 10 shown in FIG. 1, as shown in a maximum projection image 1 of FIG. 3.

In addition, the circle X in the procedure 2 is a circle having the minimum area, which includes the entire maximum projection image 1 among circles having a center at a centroid 4 of the maximum projected image 1, as shown in a circle X2 in FIG. 3.

In addition, the circle Y in the procedure 3 is a circle having a radius of ½ of a radius of the circle X2, as shown in a circle Y3 of FIG. 3.

In addition, the intersection G in the procedure 4 refers to an intersection between a point on the light absorption anisotropic film corresponding to the position of the centroid 4 of the maximum projection image 1, that is, a line which passes through the centroid 4 of the maximum projection image 1 and extends in a normal direction of the maximum projection image 1, and the light absorption anisotropic film.

In addition, each intersection in the procedure 5 refers to an intersection between each line passing through any four points Z on the circle Y2 and extending in the normal direction of the maximum projection image 1, and the light absorption anisotropic film.

In addition, the transmittance can be calculated using a spectrophotometer (manufactured by JASCO Corporation; VAP-7070) to measure the transmittance in a wavelength range of 380 to 780 nm.

In the present invention, the absolute value (ΔT₁) of the difference between the transmittance T₁₁ and the transmittance T₁₂ is preferably 0.1% or more, more preferably 0.2% or more, and still more preferably 0.3% or more.

Similarly, the absolute value (ΔT₁) of the difference between the transmittance T₁₁ and the transmittance T₁₂ is preferably 2.0% or less, and more preferably 1.8% or less.

In the present invention, with regard to the transmittance at the above-described intersection G, from the reason that the occurrence of the ghost is further suppressed in a case of being applied to a pancake lens-type virtual reality display apparatus, it is preferable that, in a case where a transmittance before heating at 120° C. for 10 minutes is denoted by T₂₁ and a transmittance after the heating is denoted by T₂₂, the following expression (2) is satisfied.

$$Δ {T}_{2} = \vert {T}_{21} - {T}_{22} \vert \leq 3. \% \qquad Expression ( 2 )$$

In addition, the absolute value (ΔT₂) of the difference between the transmittance T₂₁ and the transmittance T₂₂ is preferably 0.1% or more, more preferably 0.2% or more, and still more preferably 0.3% or more.

Similarly, the absolute value (ΔT₂) of the difference between the transmittance T₂₁ and the transmittance T₂₂ is preferably 3.0% or less, more preferably 2.8% or less, and still more preferably 2.5% or less.

In the present invention, from the reason that the occurrence of the ghost is further suppressed in a case of being applied to a pancake lens-type virtual reality display apparatus, it is preferable that, in a case where a brightness at the above-described intersection G is denoted by L₁₁* and a chromaticity is denoted by a₁₁* and b₁₁*, and a brightness at the above-described intersection A is denoted by L₁₂* and a chromaticity is denoted by a₁₂* and b₁₂*, the following expression (3) is satisfied.

$$Δ {E}_{1} = \sqrt{{( {L}_{11}^{*} - {L}_{12}^{*} )}^{2} + {( {a}_{11}^{*} - + {a}_{12}^{*} )}^{2} + {( {b}_{11}^{*} - {b}_{12}^{*} )}^{2}} ≦ 3 \qquad ( 3 )$$

In addition, ΔE₁ represented by the left side of the above expression (3) is preferably 0.5% or more, more preferably 0.6% or more, and still more preferably 0.7% or more.

Similarly, ΔE₁ represented by the left side of the above expression (3) is preferably 3.0% or less, more preferably 2.5% or less, and still more preferably 2.0% or less.

An average film thickness of the light absorption anisotropic film is not particularly limited, but is preferably 0.3 to 5.0 μm and more preferably 0.5 to 3.0 μm.

### [Dichroic Substance]

It is preferable that the light absorption anisotropic film according to the embodiment of the present invention contains a dichroic substance.

Here, the dichroic substance means a coloring agent having different absorbances depending on the direction.

In addition, the dichroic substance may or may not exhibit liquid crystallinity.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic substance, a dichroic azo coloring agent compound is preferable.

The dichroic azo coloring agent compound denotes an azo coloring agent compound having different absorbances depending on the direction. The dichroic azo coloring agent compound may or may not exhibit liquid crystallinity. In a case where the dichroic azo coloring agent compound exhibits liquid crystallinity, any of nematic properties or smectic properties may be exhibited. A temperature range at which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of tint adjustment, it is preferable to use at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more kinds of dichroic azo coloring agent compounds may be used in combination. For example, from the viewpoint of making color of the light absorption anisotropic film close to black, it is preferable to use the first dichroic azo coloring agent compound, the second dichroic azo coloring agent compound, and at least one coloring agent compound (third dichroic azo coloring agent compound) having a maximal absorption wavelength in a wavelength range of 380 nm or more and less than 455 nm in combination.

In the present invention, it is preferable that the dichroic azo coloring agent compound has a crosslinkable group.

Examples of the crosslinkable group include a (meth)acryloyl group, an epoxy group, an oxetanyl group, and a styryl group, and among these, a (meth)acryloyl group is preferable.

In the present invention, from the reason that the occurrence of the ghost is further suppressed in a case of being applied to a pancake lens-type virtual reality display apparatus, it is preferable that at least a part of the dichroic substance forms an arrangement structure. Here, the arrangement structure refers to a state in which, in the light absorption anisotropic film, the dichroic substances are collected to form an aggregate and molecules of the dichroic substances are periodically arranged in the aggregate.

In addition, the arrangement structure may be composed of only the dichroic substance, or may be composed of the liquid crystal compound and the dichroic substance.

In addition, the arrangement structure may be composed of one kind of dichroic substance, or may be composed of a plurality of kinds of dichroic substances.

In addition, an arrangement structure composed of a certain kind of dichroic substance and an arrangement structure composed of another kind of dichroic substance may coexist in the light absorption anisotropic film.

In addition, in a case where the light absorption anisotropic film contains a plurality of kinds of dichroic substances, among the plurality of kinds of dichroic substances contained in the light absorption anisotropic film, all of the plurality of kinds of dichroic substances may form the arrangement structure, or some kinds of dichroic substances may form the arrangement structure.

In addition, in the present invention, from the reason that the above expression (1) is easily satisfied by adjusting the transmittance measured by the above-described procedure and the occurrence of the ghost is further suppressed in a case of being applied to a pancake lens-type virtual reality display apparatus, in a case where 100 arrangement structures of the dichroic substance present in a cross section of the light absorption anisotropic film observed with a scanning transmission electron microscope are selected, the number of arrangement structures in which a length of a major axis is less than 50 nm is preferably 30 or less, more preferably 0 to 25, still more preferably 0 to 15, and particularly preferably 0 to 10.

Here, the observation of the cross section with a scanning transmission electron microscope (hereinafter, also referred to as “STEM”) is specifically performed as follows. First, an ultra-thin section of the light absorption anisotropic film, having a thickness of 100 nm in a film thickness direction, is produced using an ultramicrotome.

Next, the ultra-thin section is placed on a grid with a carbon support film for STEM observation.

Thereafter, the grid is placed in the scanning transmission electron microscope, and a cross section is observed at an electron beam acceleration voltage of 30 kV.

In addition, the length of the major axis of the arrangement structure is specifically measured as follows.

First, as described above, the cross section of the light absorption anisotropic film is observed with STEM, a captured image is analyzed to create a frequency histogram, and a frequency at which the frequency is maximized and a standard deviation of a frequency distribution are acquired. Next, a frequency at which the frequency is 1.3 times the standard deviation on a dark side from the frequency at which the frequency is maximized is set as a threshold value. Next, an image in which the brightness is binarized is created using the threshold value, and a portion having a major axis of 20 nm or more in the binarized dark region is extracted as the arrangement structure.

Furthermore, each of the extracted arrangement structures is approximated to an ellipse, and the length of the major axis of the approximated ellipse is set as the length of the major axis of the arrangement structure. In addition, an angle formed by an axis perpendicular to the film surface (normal direction of the light absorption anisotropic film) and a major axis of an approximate ellipse is denoted by an angle formed by the major axis of the arrangement structure and the normal direction of the light absorption anisotropic film.

The length of the major axis of the arrangement structure may be measured using known image processing software. Examples of the image processing software include image processing software “ImageJ”.

In the present invention, from the reason that the above expression (1) is easily satisfied by adjusting the transmittance measured by the above-described procedure and the occurrence of the ghost is further suppressed in a case of being applied to a pancake lens-type virtual reality display apparatus, a content of the dichroic substance is preferably 230 mg/cm³ or more, and more preferably 230 to 300 mg/cm³.

Here, the content (mg/cm³) of the dichroic substance is obtained by measuring a solution in which an optical laminate including the light absorption anisotropic film is dissolved, or an extraction liquid obtained by immersing the optical laminate in a solvent, using high performance liquid chromatography (HPLC); but the measurement method is not limited to the above-described method. In addition, the quantification can be performed by using the dichroic substance contained in the light absorption anisotropic film as a standard sample.

Examples of the method of calculating the content of the dichroic substance include a method in which the volume is calculated by multiplying the thickness of the light absorption anisotropic film obtained from a microscopic observation image of a cross section of the optical laminate by the area of the optical laminate used for measuring the coloring agent amount, and is divided by the coloring agent amount measured by HPLC to calculate the content of the coloring agent.

### [Liquid Crystal Compound]

The light absorption anisotropic film according to the embodiment of the present invention preferably contains a liquid crystal compound. In this manner, the dichroic substance can be aligned with a high alignment degree while precipitation of the dichroic substance is restrained.

As the liquid crystal compound, both a high-molecular-weight liquid crystal compound and a low-molecular-weight liquid crystal compound can be used, and from the viewpoint of increasing the alignment degree, a high-molecular-weight liquid crystal compound is preferable. In addition, the high-molecular-weight liquid crystal compound and the low-molecular-weight liquid crystal compound may be used in combination as the liquid crystal compound.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the high-molecular-weight liquid crystal compound include thermotropic liquid crystalline polymers described in JP2011-237513A and high-molecular-weight liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

Examples of such a liquid crystal compound include compounds described in paragraphs [0019] to [0140] of WO2022/014340A, the description of which is incorporated herein by reference.

A content of the liquid crystal compound in the light absorption anisotropic film is preferably 25 to 2,000 parts by mass, more preferably 100 to 1,300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved.

The liquid crystal compound may be contained only one kind or two or more kinds. In a case of containing two or more kinds of liquid crystal compounds, the above-described content of the liquid crystal compound means the total content of the liquid crystal compounds.

From the reason that the above expression (1) is easily satisfied by adjusting the transmittance measured by the above-described procedure and the occurrence of the ghost is further suppressed in a case of being applied to a pancake lens-type virtual reality display apparatus, it is preferable that the light absorption anisotropic film according to the embodiment of the present invention is a film obtained by fixing an alignment state of a liquid crystal composition containing a liquid crystal compound, and a LogP value of the liquid crystal compound is 6 or less.

In addition, the LogP value of the liquid crystal compound is more preferably 2 or more, and still more preferably 3 or more.

In addition, the upper limit thereof is more preferably 6 or less, and still more preferably 5 or less.

Here, the logP value is an index for expressing properties of hydrophilicity and hydrophobicity of a chemical structure, and is also referred to as a hydrophilic-hydrophobic parameter. The logP value can be calculated using software such as ChemBioDraw Ultra or HSPiP (Ver. 4.1.07). In addition, the Iog P value can be acquired experimentally by the method of the OECD Guidelines for the Testing of Chemicals, Sections 1, Test No. 117, or the like. In the present invention, a value calculated by inputting the structural formula of a compound to HSPiP (Ver. 4.1.07) is adopted as the logP value unless otherwise specified. In a case where the liquid crystal composition contains a plurality of kinds of liquid crystal compounds, the LogP value of the liquid crystal compound refers to a largest LogP value among LogP values of the plurality of kinds of liquid crystal compounds.

In the light absorption anisotropic film according to the embodiment of the present invention, it is preferable that the liquid crystal compound is homogeneously aligned.

In addition, it is preferable that the dichroic substance in the light absorption anisotropic film according to the embodiment of the present invention is aligned in a specific direction. Among these, in the light absorption anisotropic film, it is more preferable that the dichroic substance is aligned in one in-plane direction. In particular, it is still more preferable that the dichroic substance is also aligned in the liquid crystal compound which is homogeneously aligned.

As described later, the light absorption anisotropic film according to the embodiment of the present invention is preferably a film formed of a composition for forming a light absorption anisotropic film, which contains a liquid crystal compound and a dichroic substance.

### [Surfactant]

It is preferable that the light absorption anisotropic film according to the embodiment of the present invention contains a surfactant.

As the surfactant, it is preferable to use a compound having a so-called leveling function of making a coated film flat. For example, a silicon atom-containing compound, a polyacrylate compound, or a fluorine atom-containing compound can be used.

In particular, from the viewpoint of reducing environmental pollution, the surfactant is preferably a silicon atom-containing compound or a polyacrylate compound, and more preferably a compound having a branched siloxane structure. In particular, a copolymer described in WO2023/054164A is preferable.

A content of the surfactant in the light absorption anisotropic film is preferably 0.01% to 10%, more preferably 0.01% to 6.0%, and still more preferably 0.05% to 3.0% with respect to the total mass of the solid content of the composition for forming a light absorption anisotropic film (that is, the mass of the light absorption anisotropic film).

### Other Components

The light absorption anisotropic film may contain an adhesion improver, a plasticizer, a polymer, and the like, in addition to the above-described components.

Here, examples of the adhesion improver include reactive additives described in paragraphs [0123] to [0129] of JP2019-91088A and boronic acid monomers described in paragraphs [0015] to [0028] of WO2015/053359A.

### [Manufacturing Method of Light Absorption Anisotropic Film]

A method for manufacturing the light absorption anisotropic film according to the embodiment of the present invention is not particularly limited as long as the light absorption anisotropic film having the above-described characteristics can be manufactured.

Examples thereof include a method of manufacturing a planar light absorption anisotropic film and then forming the planar light absorption anisotropic film to produce a light absorption anisotropic film having a non-planar shape portion.

Examples of the method of forming the planar light absorption anisotropic film include a method (method 1) of using a forming die having a convex forming surface and a forming die having a concave forming surface, and a method (method 2) of heating a planar light absorption anisotropic film in an in-plane direction during forming such that a temperature distribution is provided, thereby forming the film.

In the following, first, the method of manufacturing the planar light absorption anisotropic film will be described, and then the methods 1 and 2 will be described in detail. In the following description of the methods 1 and 2, a procedure for obtaining the light absorption anisotropic film 10 shown in FIGS. 1 and 2 will be described in detail as an example.

### <Method of Manufacturing Planar Light Absorption Anisotropic Film>

The method of manufacturing the planar light absorption anisotropic film is not particularly limited, and examples thereof include known methods. Among these, a method of manufacturing the planar light absorption anisotropic film using a composition for forming a light absorption anisotropic film, which contains a dichroic substance and a liquid crystal compound, is preferable.

More specific examples thereof include a method including, in the following order, a step of applying a composition for forming a light absorption anisotropic film onto a planar substrate to form a coating film (hereinafter, also referred to as “coating film forming step”) and a step of aligning a liquid crystalline component or the dichroic substance, contained in the coating film (hereinafter, also referred to as “alignment step”).

In a case where the above-described dichroic substance has liquid crystallinity, the liquid crystalline component is a component which also includes the dichroic substance having liquid crystallinity in addition to the above-described liquid crystal compound.

### —Coating Film Forming Step—

The coating film forming step is a step of applying the above-described composition for forming a light absorption anisotropic film onto a planar substrate to form a coating film.

The composition for forming a light absorption anisotropic film contains the dichroic substance and the liquid crystal compound described above. The dichroic substance and the liquid crystal compound contained in the composition for forming a light absorption anisotropic film may have a polymerizable group. As the polymerizable group, an acryloyl group, a methacryloyl group, an epoxy group, an oxetanyl group, or a styryl group is preferable; and an acryloyl group or a methacryloyl group is more preferable. In a case where the dichroic substance and the liquid crystal compound have a polymerizable group, these compounds can be immobilized in the light absorption anisotropic film in a curing step described later.

The substrate used in this step is not particularly limited, and a known planar substrate can be used.

In addition, an alignment film may be provided on the substrate as necessary. By providing the alignment film, the liquid crystalline component can be aligned. Examples of the alignment film include a photo-alignment film.

In the present step, the composition for forming a light absorption anisotropic film can be easily applied by using a composition for forming a light absorption anisotropic film, which contains a solvent, or using a liquid such as a melt obtained by heating the composition for forming a light absorption anisotropic film.

Examples of the method of applying the composition for forming a light absorption anisotropic film include known methods such as a roll coating method, a gravure printing method, a spin coating method, a wire bar coating method, an extrusion coating method, a direct gravure coating method, a reverse gravure coating method, a die-coating method, a spraying method, and an ink jet method.

### —Alignment Step—

The alignment step is a step of aligning the liquid crystalline component contained in the coating film. In this manner, the planar light absorption anisotropic film is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystalline component contained in the composition for forming a light absorption anisotropic film may be aligned by the coating film forming step or the drying treatment described above. For example, in an aspect in which the composition for forming a light absorption anisotropic film is prepared as a coating liquid containing a solvent, a coating film having light absorption anisotropy is obtained by drying the coating film and removing the solvent from the coating film.

In a case where the drying treatment is performed at a temperature equal to or higher than a transition temperature of the liquid crystalline component contained in the coating film from a liquid crystal phase to an isotropic phase, a heat treatment described below may not be performed.

From the viewpoint of manufacturing suitability or the like, a transition temperature of the liquid crystalline component contained in the coating film from the liquid crystal phase to the isotropic phase is preferably 10° C. to 250° C. and more preferably 25° C. to 190° C. In a case where the transition temperature is 10° C. or higher, a cooling treatment or the like for lowering the temperature to a temperature range in which the liquid crystal phase is exhibited is not necessary, which is preferable. In addition, in a case where the transition temperature is 250° C. or lower, a high temperature is not required even in a case where the coating film is heated until the phase transition to the isotropic phase is made for the purpose of suppressing alignment defects and waste of thermal energy and deformation and deterioration of the substrate can be reduced, which is preferable.

It is preferable that the alignment step includes a heat treatment. In this manner, since the liquid crystalline component contained in the coating film can be aligned, the coating film after being subjected to the heat treatment can be suitably used as the light absorption anisotropic film.

From the viewpoint of manufacturing suitability, the heating temperature is preferably 10° C. to 250° C. and more preferably 25° C. to 190° C. In addition, the heating time is preferably 1 to 300 seconds and more preferably 1 to 60 seconds.

In the present invention, from the reason that the above expression (1) is easily satisfied by adjusting the transmittance measured by the above-described procedure and the occurrence of the ghost is further suppressed in a case of being applied to a pancake lens-type virtual reality display apparatus, it is preferable to perform the heat treatment multiple times.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

### Other Steps

The method of forming the planar light absorption anisotropic film may include a step of curing the light absorption anisotropic film after the above-described alignment step (hereinafter, also referred to as “curing step”).

The curing step is performed by heating the light absorption anisotropic film and/or irradiating the light absorption anisotropic film with light (exposing the light absorption anisotropic film to light), for example, in a case where the compound contained in the light absorption anisotropic film has a polymerizable group. Among these, from the viewpoint of productivity, it is preferable that the curing step is performed by irradiating the light absorption anisotropic film with light.

Various light sources such as infrared rays, visible light, and ultraviolet rays can be used as a light source for the curing, but ultraviolet rays are preferable. In addition, ultraviolet rays may be applied while the light absorption anisotropic film is heated during the curing, or ultraviolet rays may be applied through a filter which transmits only a specific wavelength.

In a case where the exposure is performed while the light absorption anisotropic film is heated, the heating temperature during the exposure depends on the transition temperature of the liquid crystalline component contained in the liquid crystal film, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

### Method 1

The method 1 is a method of using a forming die having a convex forming surface and a forming die having a concave forming surface.

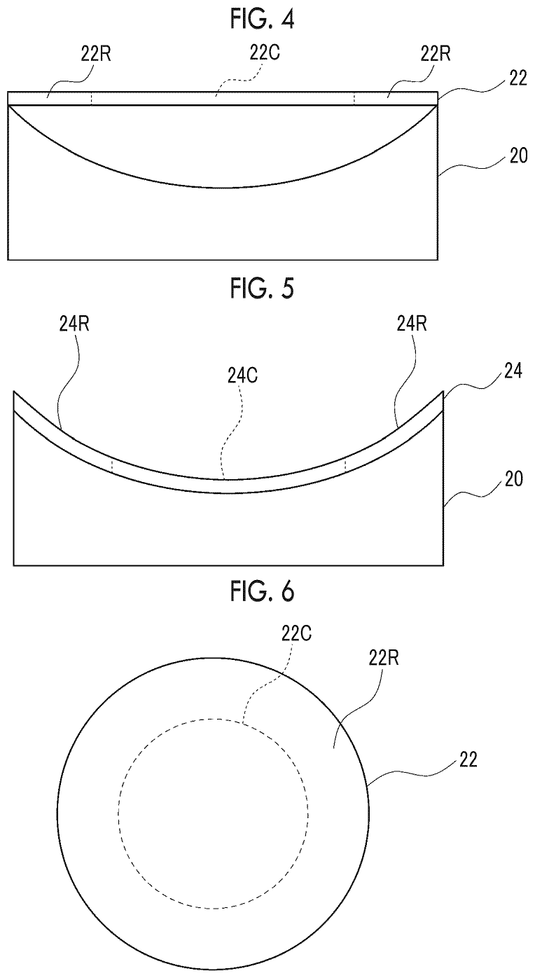

First, a phenomenon occurring in a case of forming a film using a forming die having a concave forming surface will be described with reference to FIGS. 4 to 6. FIGS. 4 and 5 show a procedure for forming a film using a forming die having a concave forming surface, and FIG. 6 shows the film used for the forming.

As shown in FIG. 4, a circular film 22 is placed on a forming die 20 having a concave forming surface, and as shown in FIG. 5, the film 22 is deformed along a forming surface of the forming die 20, whereby a film 24 with the concave surface shape transferred is obtained.

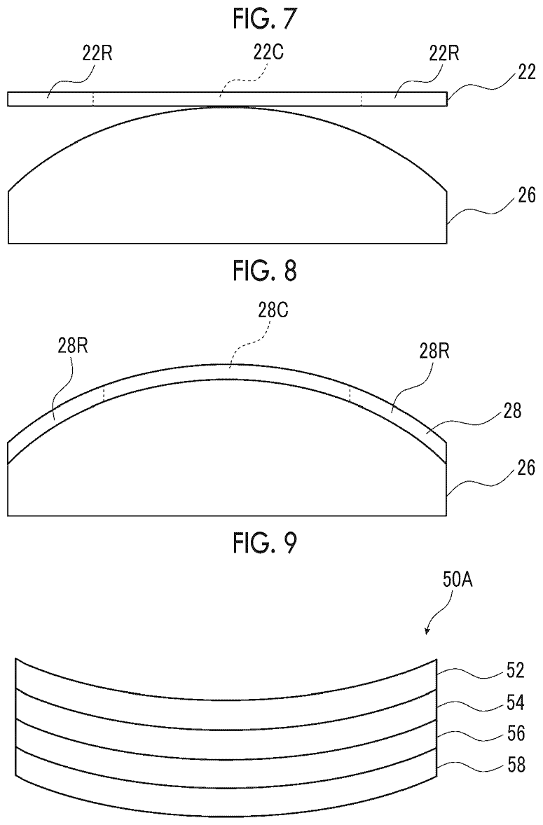

Next, a phenomenon occurring in a case of forming a film using a forming die having a convex forming surface will be described with reference to FIGS. 6 to 8. FIGS. 7 and 8 show a procedure for forming a film using a forming die having a convex forming surface, and FIG. 6 shows the film used for the forming.

As shown in FIG. 7, a circular film 22 is placed on a forming die 26 having a convex forming surface, and as shown in FIG. 8, the film 22 is deformed along a forming surface of the forming die 26, whereby a film 28 with the convex surface shape transferred is obtained.

### Method 2

The method 2 is a method of heating a planar light absorption anisotropic film in an in-plane direction during forming such that a temperature distribution is provided, thereby forming the film.

Examples of a first aspect of the method 2 include a method of heating a planar light absorption anisotropic film such that a heating temperature of a periphery portion surrounding a center portion of the planar light absorption anisotropic film is higher than a heating temperature of the center portion, and deforming the heated planar light absorption anisotropic film along a forming surface of a forming die having a concave surface shape.

In addition, examples of a second aspect of the method 2 include a method of heating a planar light absorption anisotropic film such that a heating temperature of a periphery portion surrounding a center portion of the planar light absorption anisotropic film is lower than a heating temperature of the center portion, and deforming the heated planar light absorption anisotropic film along a forming surface of a forming die having a convex surface shape.

Hereinafter, the first aspect of the method 2 will be typically described with reference to the drawings.

In the method 2, the heating conditions for the light absorption anisotropic film are appropriately selected depending on the type of the materials of the light absorption anisotropic film to be used and the shape of the non-planar shape portion.

Among these, the heating temperature is preferably equal to or higher than a glass transition temperature of the light absorption anisotropic film. The upper limit of the heating temperature is not particularly limited, but is preferably a temperature within (Glass transition temperature of light absorption anisotropic film+100° C.).

In the above description, the heating of the light absorption anisotropic film itself has been described, but a laminate described later may be applied to the method 2. In that case, in a case where the laminate includes a support, it is preferable to heat the support to a temperature equal to or higher than a glass transition temperature of the support during the heating treatment.

The heating method in the method 2 is not particularly limited, and examples thereof include heating by bringing the light absorption anisotropic film into contact with a heated solid, heating by bringing the light absorption anisotropic film into contact with a heated liquid, heating by bringing the light absorption anisotropic film into contact with a heated gas, heating by irradiation with infrared rays, and heating by irradiation with microwaves. Among these, heating by irradiation with infrared rays is preferable because it allows for remote heating just before the forming.

A wavelength of the infrared rays used for the heating is preferably 1.0 to 30.0 μm and more preferably 1.5 to 5 μm.

Examples of the infrared ray (IR) light source include a near-infrared lamp heater in which a tungsten filament is enclosed into a quartz tube, and a wavelength control heater in which a mechanism for cooling a part between quartz tubes with air is provided by multiplexing the quartz tubes. As a method of providing intensity distribution of the infrared irradiation, a method of varying the density of the arrangement of the IR light sources, or a method of placing a filter with a patterned transmittance to infrared light between the IR light sources and the planar light absorption anisotropic film can be used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, or the like is used. The temperature of the planar light absorption anisotropic film is controlled by the intensity of the infrared irradiation, and the temperature is controlled by the infrared irradiation time and the illuminance of the infrared irradiation. The temperature of the planar light absorption anisotropic film can be monitored using a non-contact radiation thermometer, a thermocouple, or the like, and the forming can be performed at a target temperature.

### [Laminate]

The laminate according to the embodiment of the present invention includes the above-described light absorption anisotropic film.

The laminate according to the embodiment of the present invention includes other members in addition to the above-described light absorption anisotropic film; and the other members are not particularly limited, and examples thereof include a retardation layer, a reflective polarizer layer (for example, a cholesteric liquid crystal layer, a linear polarization-type reflective polarizer, and the like), a surface antireflection layer, a pressure-sensitive adhesive layer, a support, and an alignment film.

Among these, suitable examples of the other members include a retardation layer and a reflective polarizer layer. That is, the laminate according to the embodiment of the present invention is preferably a laminate including a light absorption anisotropic film, a retardation layer, and a reflective polarizer layer.

FIG. 9 shows an example of the laminate according to the embodiment of the present invention.

A laminate 50A shown in FIG. 9 includes a light absorption anisotropic film 52, a retardation layer 54 having a function of converting linearly polarized light into circularly polarized light, a positive C-plate 56, and a cholesteric liquid crystal layer 58 in this order.

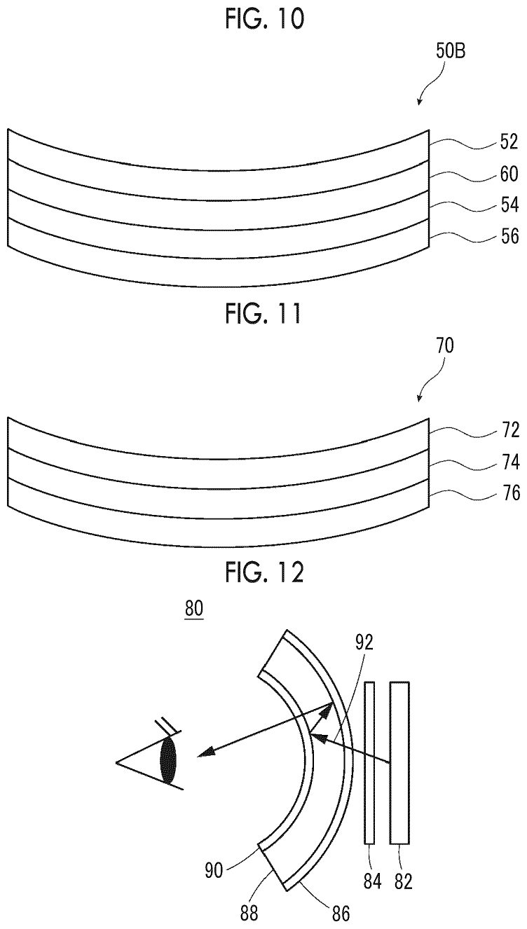

FIG. 10 shows another example of the laminate according to the embodiment of the present invention.

A laminate 50B shown in FIG. 10 includes a light absorption anisotropic film 52, a linear polarization-type reflective polarizer 60, a retardation layer 54 having a function of converting linearly polarized light into circularly polarized light, and a positive C-plate 56 in this order.

As shown in FIGS. 9 and 10, any member included in the laminate 50A and the laminate 50B has the same curved surface shape as the light absorption anisotropic film 52.

In a case where the retardation layer 54 in the laminate 50A and the laminate 50B is a λ/4 plate, an angle formed by a slow axis of the retardation layer 54 and a transmission axis of the light absorption anisotropic film 52 is preferably within a range of 45°±10°. The laminate 50A and the laminate 50B include two retardation layers of the retardation layer 54 and the positive C-plate 56.

A retardation layer having a function of converting linearly polarized light into circularly polarized light may be further disposed on a side of the light absorption anisotropic film 52 of the laminate 50A, opposite to the retardation layer 54 side. In addition, a retardation layer having a function of converting linearly polarized light into circularly polarized light may be further disposed on a side of the light absorption anisotropic film 52 of the laminate 50B, opposite to the linear polarization-type reflective polarizer 60 side.

The laminates 50A and 50B are suitably applied to a virtual reality display apparatus described later.

The light absorption anisotropic film 52 is the above-described light absorption anisotropic film. The light absorption anisotropic film 52 is a film corresponding to the light absorption anisotropic film 10 shown in FIGS. 1 and 2.

Hereinafter, other members other than the light absorption anisotropic film, included in the laminate, will be described in detail.

[Retardation Layer Having Function of Converting Linearly Polarized Light into Circularly Polarized Light]

The retardation layer having a function of converting linearly polarized light into circularly polarized light (hereinafter, also simply referred to as “specific retardation layer”) is one kind of retardation layer.

The specific retardation layer is not particularly limited as long as it has a function of converting linearly polarized light into circularly polarized light, and examples thereof include a λ/4 plate.

The λ/4 plate is a plate having λ/4 function, specifically, a plate having a function of converting linearly polarized light having a specific wavelength (preferably, visible light) into circularly polarized light (or converting circularly polarized light into linearly polarized light). An in-plane retardation of the λ/4 plate at a wavelength of 550 nm is not particularly limited, but is preferably 120 to 150 nm, more preferably 125 to 145 nm, and still more preferably 135 to 140 nm.

In addition to the λ/4 plate, a retardation layer in which an in-plane retardation at a wavelength of 550 nm is ¾ or 5/4 of a wavelength of any light of visible light is also preferable.

The specific retardation layer may have reverse wavelength dispersibility. The expression “having reverse wavelength dispersibility” denotes that as the wavelength increases, the value of the phase difference at the wavelength increases.

In addition, the specific retardation layer may have a multilayer structure, and specific examples thereof include a broadband λ/4 plate obtained by laminating a λ/4 plate and a λ/2 plate.

An angle formed by a slow axis of the specific retardation layer and an absorption axis of the light absorption anisotropic film is not particularly limited, but is preferably within a range of 45°±10°.

The specific retardation layer may be a layer formed by immobilizing a liquid crystal compound twist-aligned with a thickness direction as a helical axis. For example, a retardation layer having a layer formed by immobilizing a rod-like liquid crystal compound or a disk-like liquid crystal compound twist-aligned with a thickness direction as a helical axis, as described in JP05753922B and JP05960743B, can be used.

A thickness of the specific retardation layer is not particularly limited, but is preferably 0.1 to 8 μm and more preferably 0.3 to 5 μm.

### [Positive C-Plate]

The positive C-plate is one type of retardation layer.

The positive C-plate is a retardation layer in which an in-plane retardation is substantially zero and a thickness-direction retardation has a negative value. The positive C-plate functions as an optical compensation layer for increasing the degree of polarization of the transmitted light with respect to light incident obliquely.

The in-plane retardation of the positive C-plate at a wavelength of 550 nm is preferably 10 nm or less.

The thickness-direction retardation of the positive C-plate at a wavelength of 550 nm is preferably −600 to −40 nm.

A material constituting the positive C-plate is not particularly limited, but it is preferable that the positive C-plate is formed of a composition containing a liquid crystal compound. Such a positive C-plate can be typically obtained by vertically aligning a rod-like polymerizable liquid crystal compound contained in the polymerizable liquid crystal composition and fixing the alignment state by polymerization. In addition, the positive C-plate can also be formed of a composition containing a side chain-type polymer liquid crystal compound as the liquid crystal compound.

A thickness of the positive C-plate is not particularly limited, but from the viewpoint of thinning, it is preferably 0.5 to 10 μm and more preferably 0.5 to 5 μm.

### [Cholesteric Liquid Crystal Layer]

The cholesteric liquid crystal layer is an optical member which separates incidence ray into right-circularly polarized light and left-circularly polarized light, and specularly reflects one circularly polarized light and transmits the other circularly polarized light.

Examples of the cholesteric liquid crystal layer include a cholesteric liquid crystal layer obtained by fixing a cholesteric liquid crystalline phase. From the viewpoint that a decrease in degree of polarization and a distortion of a polarization axis are suppressed in a case of being stretched or formed into a three-dimensional shape, the cholesteric liquid crystal layer is preferably used as an optical film for curved surface forming. In addition, a decrease in degree of polarization due to the distortion of the polarization axis is unlikely to occur.

It is preferable that the cholesteric liquid crystal layer includes a blue light reflecting layer in which at least reflectivity at a wavelength of 460 nm is 40% or more, a green light reflecting layer in which a reflectivity at a wavelength of 550 nm is 40% or more, a yellow light reflecting layer in which a reflectivity at a wavelength of 600 nm is 40% or more, and a red light reflecting layer in which a reflectivity at a wavelength of 650 nm is 40% or more. With such a configuration, high reflection characteristics can be exhibited over a wide wavelength range in the visible region, which is preferable. The above-described reflectivity is a reflectivity in a case where non-polarized light is incident on the cholesteric liquid crystal layer at each wavelength.

In addition, the cholesteric liquid crystal layer may have a pitch gradient structure in which a helical pitch of the cholesteric liquid crystalline phase continuously changes in the thickness direction.

In addition, it is also preferable that a cholesteric liquid crystal layer obtained by fixing a cholesteric liquid crystalline phase containing a rod-like liquid crystal compound and a cholesteric liquid crystal layer obtained by fixing a cholesteric liquid crystalline phase containing a disk-like liquid crystal compound are used in combination as the cholesteric liquid crystal layer. In such a configuration, since the cholesteric liquid crystalline phase containing a rod-like liquid crystal compound has a positive Rth and the cholesteric liquid crystalline phase containing a disk-like liquid crystal compound has a negative Rth, the Rth of each other is offset, and thus the occurrence of the ghost can be suppressed even for the light incident from the oblique direction, which is preferable.

A thickness of the cholesteric liquid crystal layer is not particularly limited, but from the viewpoint of thinning, it is preferably 30 μm or less and more preferably 15 μm or less. The lower limit thereof is not particularly limited, but is 1 μm or more in many cases.

### [Linear Polarization-Type Reflective Polarizer]

The linear polarization-type reflective polarizer is a polarizer having a function of reflecting one linearly polarized light of linearly polarized light components orthogonal to each other, and allowing transmission of the other linearly polarized light components.

Examples of the linear polarization-type reflective polarizer include a film obtained by stretching a dielectric multi-layer film and a wire grid polarizer. Examples of a commercially available product include a reflective type polarizer (trade name: APF) manufactured by 3M and a wire grid polarizer (trade name: WGF) manufactured by Asahi Kasei Corporation.

### [Surface Antireflection Layer]

The laminate according to the embodiment of the present invention may include a surface antireflection layer.

In the laminate according to the embodiment of the present invention, the surface antireflection layer is preferably disposed on the outermost surface side. The surface antireflection layer may be disposed only on one surface side of the laminate, or may be disposed on both surface sides of the laminate.

The type of the surface antireflection layer is not particularly limited, but from the viewpoint of further decreasing the reflectivity, a moth-eye film or an anti reflection (AR) film is preferable. In addition, since the antireflection property can be maintained even in a case where the film thickness fluctuates due to stretching and forming, a moth-eye film is preferable. An angle formed by a transmission axis of the linear polarization-type reflective polarizer and a transmission axis of the light absorption anisotropic film is preferably within a range of 0° to 10°.

### [Pressure-Sensitive Adhesive Layer]

The laminate according to the embodiment of the present invention may or may not include a pressure-sensitive adhesive layer. In a case where the laminate includes a pressure-sensitive adhesive layer, the number of pressure-sensitive adhesive layers is preferably one or two.

Examples of a pressure-sensitive adhesive constituting the pressure-sensitive adhesive layer include a pressure sensitive adhesive and an adhesive.

Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive; and among these, an acrylic pressure sensitive adhesive (pressure-sensitive adhesive) is preferable.

Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet-curable adhesive, and a visible light-curable adhesive; and among these, an ultraviolet-curable adhesive is preferable.

A thickness of the pressure-sensitive adhesive layer is not particularly limited, but from the viewpoint of thinning, it is preferably 25 μm or less, more preferably 15 μm or less, and still more preferably 5 μm or less. The lower limit thereof is not particularly limited, but is 0.1 μm or more in many cases.

### [Support]

The laminate according to the embodiment of the present invention may include a support.

The support can be provided at any position, and for example, in a case where the cholesteric liquid crystal layer and the retardation layer are a film used by being transferred from the temporary support, the support can be used as a transfer destination thereof.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, as the support, a cellulose acylate film, a cyclic polyolefin film, polyacrylate, a polyacrylate film, or a polymethacrylate film is preferable. In addition, commercially available cellulose acetate films (for example, “TD80U” or “Z-TAC” manufactured by FUJIFILM Corporation) can also be used.

In addition, it is preferable that the support has a small phase difference. Specifically, an in-plane retardation at a wavelength of 550 nm is preferably 10 nm or less, and an absolute value of the thickness-direction retardation at a wavelength of 550 nm is preferably 50 nm or less.

From the viewpoint of stretching and forming treatment, the support preferably has a tan δ peak temperature of 170° C. or lower. From the viewpoint that the forming can be performed at a low temperature, the tan δ peak temperature is preferably 150° C. or lower and more preferably 130° C. or lower.

Here, a method of measuring tan δ will be described. E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measuring temperature: −150° C. to 220° C.
Temperature rising condition: 5° C./min
Frequency: 1 Hz

A thickness of the support is not particularly limited, and is preferably 5 to 300 μm, more preferably 5 to 100 μm, and still more preferably 5 to 30 μm.

A thickness of the laminate is not particularly limited, but in a case where the laminate does not include the pressure-sensitive adhesive layer and the support, the thickness of the laminate is preferably 30 μm or less, and more preferably 25 μm or less. The lower limit thereof is not particularly limited, but is 10 μm or more in many cases.

In a case where the laminate includes one of the pressure-sensitive adhesive layer and the support but does not include the other, a value obtained by subtracting a thickness of the one from the thickness of the laminate is preferably 30 μm or less, and more preferably 25 μm or less. The lower limit thereof is not particularly limited, but is 10 μm or more in many cases.

In a case where the laminate includes both the pressure-sensitive adhesive layer and the support, a value obtained by subtracting a thickness of the pressure-sensitive adhesive layer and a thickness of the support from the thickness of the laminate is preferably 30 μm or less, and more preferably 25 μm or less. The lower limit thereof is not particularly limited, but is 10 μm or more in many cases.

### [Method for Manufacturing Laminate]

A method for manufacturing the laminate according to the embodiment of the present invention is not particularly limited, and examples thereof include known methods.

For example, the laminate may be manufactured by bonding other members to the surface of the light absorption anisotropic film having a non-planar shape portion, through the pressure-sensitive adhesive layer; or a laminate for forming may be manufactured by bonding other members to the surface of the planar light absorption anisotropic film through the pressure-sensitive adhesive layer, and then performing the forming method of the light absorption anisotropic film described in the above-described method 1 or 2 using the laminate for molding to form the laminate for forming into a predetermined shape, thereby manufacturing the laminate including the light absorption anisotropic film having a non-planar shape portion.

### [Composite Lens]

The composite lens according to the embodiment of the present invention includes the above-described laminate according to the embodiment of the present invention, a lens, and a half mirror in this order.

FIG. 11 shows an example of the composite lens according to the embodiment of the present invention.

A composite lens 70 includes a laminate 72, a lens 74, and a half mirror 76 in this order.

As shown in FIG. 11, any member included in the composite lens 70 has a curved surface shape similar to that of the light absorption anisotropic film.

The configuration of the laminate 72 is as described above.

Hereinafter, members other than the laminate, included in the composite lens, will be described in detail.

### [Lens]

The composite lens includes a lens.

Examples of the lens include a convex lens and a concave lens.

Examples of the convex lens include a biconvex lens, a plano-convex lens, and a convex meniscus lens. Examples of the concave lens include a biconcave lens, a plano-concave lens, and a concave meniscus lens.

As the lens used in the virtual reality display apparatus, a convex meniscus lens or a concave meniscus lens is preferable from the viewpoint of enlarging the angle of view, and a concave meniscus lens is more preferable from the viewpoint that chromatic aberration can be further suppressed.

As a material of the lens, a material transparent to visible light, such as glass, crystal, and plastic, can be used. Since the birefringence of the lens causes rainbow-like unevenness or light leakage, it is preferable that the birefringence is small, and a material having zero birefringence is more preferable.

### [Half Mirror]

The composite lens according to the embodiment of the present invention includes a half mirror. The half mirror is a known half mirror in the related art, which allows transmission of about half of incident light and reflects the remaining half of the incident light.

A transmittance of the half mirror is preferably 50±30% and more preferably 50±10%.

The type of the half mirror is not particularly limited, and examples thereof include a reflective layer containing a metal. Examples of the metal include silver and aluminum.

A thickness of the reflective layer is preferably 1 to 20 nm, more preferably 2 to 10 nm, and still more preferably 3 to 6 nm.

### [Virtual Reality Display Apparatus]

The virtual reality display apparatus according to the embodiment of the present invention includes the above-described light absorption anisotropic film, laminate, or composite lens according to the embodiments of the present invention.

FIG. 12 is a schematic view showing an example of a configuration of the virtual reality display apparatus.

A virtual reality display apparatus 80 shown in FIG. 12 includes, from the right side in the drawing, an image display panel 82, a circularly polarizing plate 84, a half mirror 86, a lens 88, and a laminate 90 according to the embodiment of the present invention. The laminate 90 used in FIG. 12 has the same configuration as the above-described laminate 50A, and the light absorption anisotropic film 52 is disposed on the near side.

The composite lens described above is configured by the laminate 90, the lens 88, and the half mirror 86 shown in FIG. 12.

In the virtual reality display apparatus 80 shown in FIG. 12, a ray 92 emitted from an image display panel 82 is transmitted through a circularly polarizing plate 84 to be circularly polarized light, and is transmitted through a half mirror 86. Next, the ray transmits through the lens 88, is incident from the side of the reflective polarizer layer (for example, the cholesteric liquid crystal layer) included in the laminate 90 according to the embodiment of the present invention, is reflected, transmits through the lens 88 again, is reflected by the half mirror 86 again, and is incident into the laminate 90 after being transmitted through the lens 88 again. In this case, the circular polarization state of the ray 92 does not change in a case where the ray 92 is reflected from the laminate 90, and changes to circular polarization having a turning direction opposite to that of the circular polarization incident on the laminate 90 in a case where the ray 92 is reflected from the half mirror 86. Therefore, the ray 92 is transmitted through the laminate 90, and visually recognized by a user. Furthermore, in a case where the ray 92 is reflected by the half mirror 86, since the half mirror has a concave mirror shape, the image is magnified so that the user can visually recognize the magnified virtual image. The system described above is referred to as a reciprocating optical system, a folded optical system, or the like.

The light absorption anisotropic film according to the embodiment of the present invention, included in the laminate 90, functions as a so-called linear polarizer, and is used to prevent light which is unnecessarily transmitted through the cholesteric liquid crystal layer from being observed by the user of the virtual reality display apparatus as a leakage light (ghost). In the light absorption anisotropic film according to the embodiment of the present invention, since the transmittance measured by the above-described procedure satisfies the above expression (1), the occurrence of the leaked light (ghost) can be suppressed.

The image display panel 82 is, for example, a known image display panel (display panel) such as an organic electroluminescence display panel.

In the illustrated example, the image display panel 82 emits an image (image light) of unpolarized light. The unpolarized image emitted from the image display panel 82 passes through the circularly polarizing plate 84, and is converted into circularly polarized light.

### EXAMPLES

Hereinbelow, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited by the following examples.

### Example 1

### [Production of Absorptive Polarizing Film 1 Including Light Absorption Anisotropic Film]

### <Production of Support>

The following composition was put into a mixing tank, stirred, and heated at 90° C. for 10 minutes. Thereafter, the obtained composition was filtered through a filter paper having an average hole diameter of 34 μm and a sintered metal filter having an average hole diameter of 10 μm to prepare a dope. The concentration of solid contents of the dope was 23.5% by mass, the amount of the plasticizer added was a proportion to cellulose acylate, and the solvent of the dope was methylene chloride/methanol/butanol=81/18/1 (mass ratio).

Cellulose acylate dope

| | |
|---|---|
| Cellulose acylate (acetyl substitution | 100 parts by mass |
| degree: 2.86, viscosity average degree of | |
| polymerization: 310) | |
| Sugar ester compound 1 (Formula (S4) shown | 6.0 parts by mass |
| below) | |
| Sugar ester compound 2 (Formula (S5) shown | 2.0 parts by mass |
| below) | |
| Silica particle dispersion (AEROSIL R972, | 0.1 parts by mass |
| manufactured by Nippon Aerosil Co., Ltd.) | |
| Solvent (methylene chloride/methanol/ | 351.9 parts by mass |
| butanol) | |

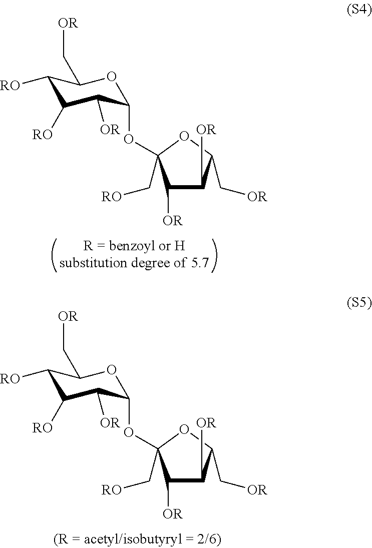

The dope produced above was cast using a drum film forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum, and then dried in a tenter device for 20 minutes at 30° C. to 40° C. during film transport, and the tenter device transported the web by clipping both ends of the web. Subsequently, the web was post-dried by zone heating while being rolled. The obtained web was subjected to knurling and then wound to obtain a cellulose acylate film A1.

In the obtained cellulose acylate film A1, a film thickness was 60 μm, an in-plane retardation Re(550) at a wavelength of 550 nm was 1 nm, and a thickness-direction retardation Rth(550) at a wavelength of 550 nm was 35 nm.

### <Formation of Photo-Alignment Film B1>

A cellulose acylate film A1 described below was continuously coated with a composition B1 for forming a photo-alignment film described below with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B1, thereby obtaining a triacetyl cellulose (TAC) film with the photo-alignment film. A film thickness of the photo-alignment film B1 was 1.5 μm.

Formulation of composition B1 for forming photo-alignment film

| | |
|---|---|
| Photo-alignment compound PA-1 shown below | 100.00 parts by mass |
| EPICLON N-695 (manufactured by DIC | 55.74 parts by mass |
| Corporation) | |
| jER YX7400 (manufactured by Mitsubishi | 18.75 parts by mass |
| Chemical Corporation) | |
| Polymerizable polymer PA-2 shown below | 8.01 parts by mass |
| Thermal cationic polymerization initiator | 16.75 parts by mass |
| PAG-1 shown below | |
| Stabilizer DIPEA shown below | 1.06 parts by mass |
| Butyl acetate | 1230.49 parts by mass |

### Photo-Alignment Compound PA-1

(in the formula, the numerical value described in each repeating unit denotes the content (% by mass) of each repeating unit with respect to all repeating units; weight-average molecular weight: 32,000)

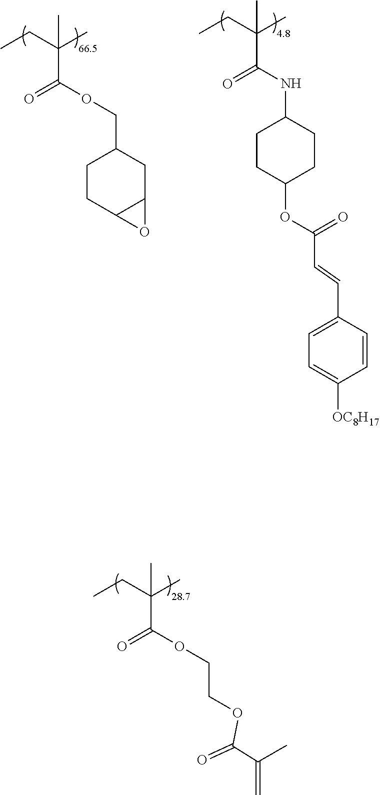

### Polymerizable Polymer PA-2

[in the formula, numerical values of a, b, and c represent contents (% by mass) of each repeating unit with respect to all the repeating units); weight-average molecular weight: 18,000]

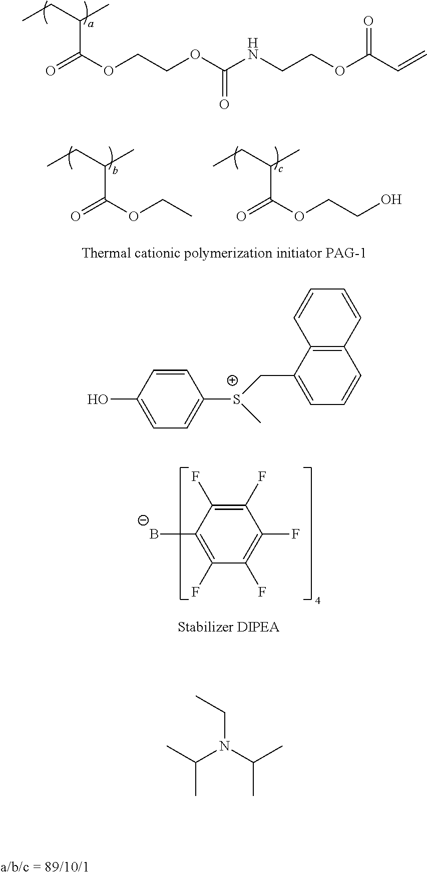

### <Formation of Light Absorption Anisotropic Film C1>

A coating film was formed by coating the obtained photo-alignment film B1 with a composition C1 for forming a light absorption anisotropic film, having the following formulation, with a wire bar.

Next, the coating film was heated at 140° C. for 15 seconds (first heating step) and heated at 80° C. for 5 seconds, and the coating film was cooled to room temperature (25° C.).

Next, the coating film was heated at 100° C. for 15 seconds (second heating step) and cooled to room temperature again.

Thereafter, the coating film was irradiated with a light emitting diode (LED) lamp (central wavelength: 365 nm) under an irradiation condition of an illuminance of 200 mW/cm² for 2 seconds, thereby producing a light absorption anisotropic film (polarizer) C1 having a thickness of 1.6 μm on the photo-alignment film B1.

In a case where a transmittance of the light absorption anisotropic film C1 in a wavelength range of 380 to 780 nm was measured with a spectrophotometer, and the average transmittance of visible light was 43%.

An absorption axis of the light absorption anisotropic film C1 was in the plane of the light absorption anisotropic film C1, and was orthogonal to a width direction of the cellulose acylate film A1.

Composition C1 for forming light absorption anisotropic film

| | |
|---|---|
| Dichroic substance Dye-Y1 shown below | 0.013 parts by mass |
| Dichroic substance Dye-M1 shown below | 0.08 parts by mass |
| Dichroic substance Dye-C1 shown below | 0.08 parts by mass |
| Dichroic substance Dye-C2 shown below | 0.25 parts by mass |
| Liquid crystal compound L-1 shown below | 1.43 parts by mass |
| Liquid crystal compound L-2 shown below | 0.61 parts by mass |
| Adhesion improver A-1 shown below | 0.04 parts by mass |
| Polymerization initiator IRGACURE OXE-02 | 0.08 parts by mass |
| (manufactured by BASF) | |
| Surfactant F-1 shown below | 0.007 parts by mass |
| Cyclopentanone | 94.96 parts by mass |
| Benzyl alcohol | 2.43 parts by mass |

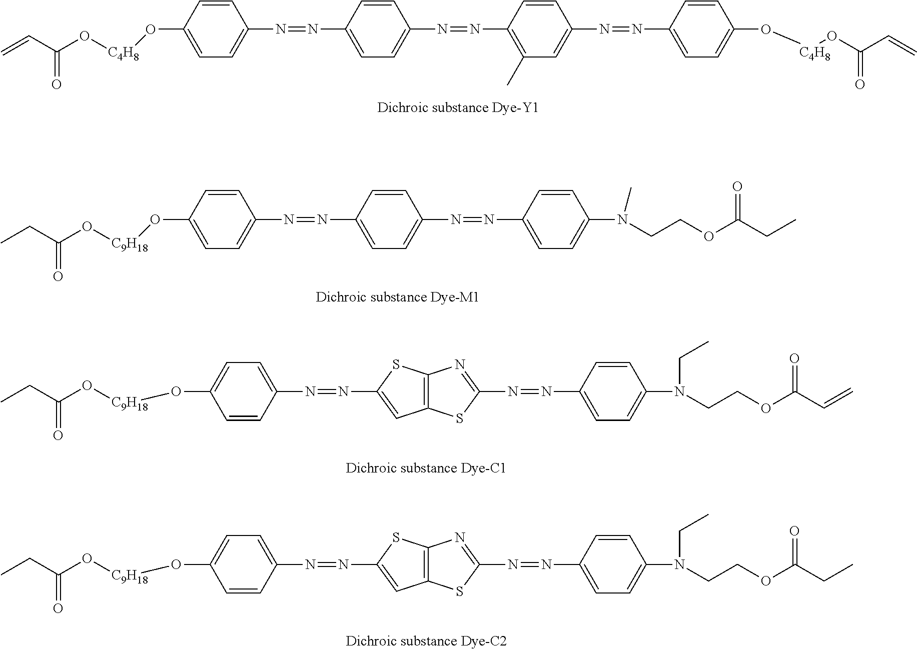

Liquid crystal compound L-1
[in the formula, the numerical values (“59”, “15”, and “26”) described in each repeating unit denote the content (% by mass) of each repeating unit with respect to all repeating units; weight-average molecular weight: 18,000]

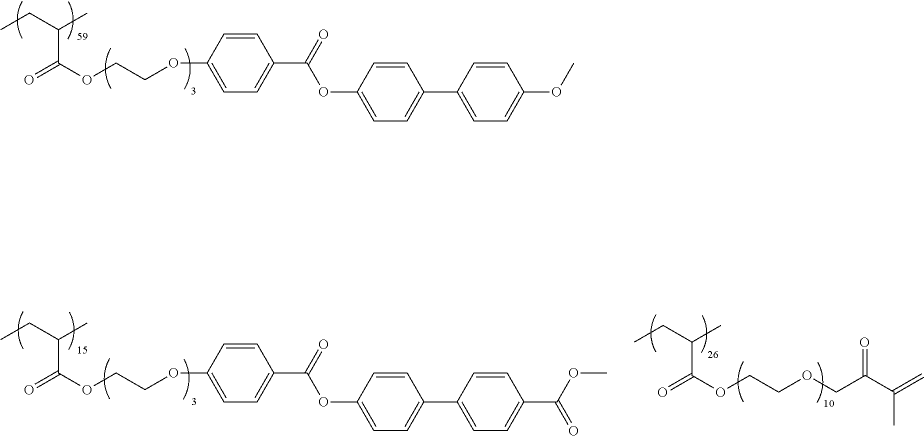

Liquid crystal compound L-2 (mixture of the following liquid crystal compounds (RA), (RB), and (RC) at a mass ratio of 84:14:2)

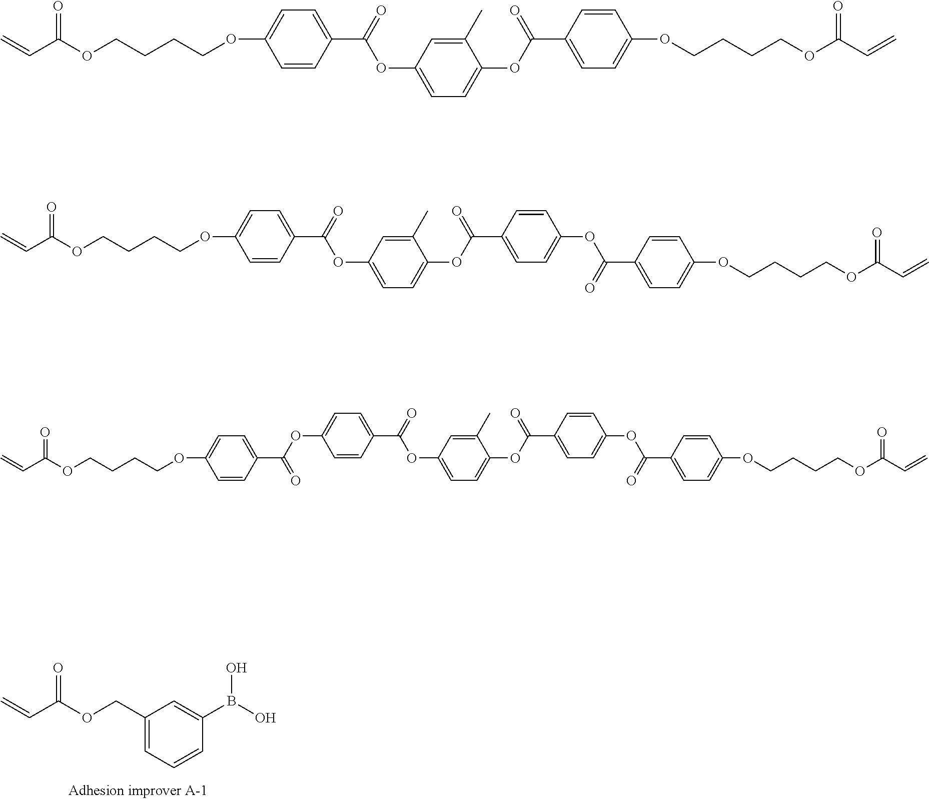

### Surfactant F-1

[in the formula, the numerical value described in each repeating unit denotes the content (% by mass) of each repeating unit with respect to all repeating units; weight-average molecular weight: 14,000]

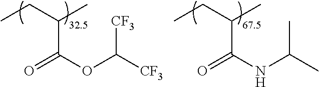

### <Formation of Protective Layer D1>

The light absorption anisotropic film C1 was continuously coated with a coating liquid D1 for forming a protective layer, having the following formulation, with a wire bar.

Thereafter, the coating film was dried with hot air at 80° C. for 5 minutes and irradiated with light at an irradiation amount of 300 mJ using a light emitting diode (LED) lamp (central wavelength: 365 nm) to obtain a laminate with the protective layer D1 consisting of polyvinyl alcohol (PVA) and having a thickness of 0.6 μm was formed, that is, an absorptive polarizing film 1 in which the cellulose acylate film A1 (support), the photo-alignment film B1, the light absorption anisotropic film C1, and the protective layer D1 were provided adjacent to each other in this order.

Formulation of coating liquid D1 for forming protective layer

| | | |
|---|---|---|
| Modified polyvinyl alcohol shown below | 3.31 | parts by mass |
| Initiator IRGACURE 2959 | 0.17 | parts by mass |
| (manufactured by BASF) | | |
| Glutaraldehyde | 0.07 | parts by mass |
| Pyridinium paratoluene sulfonate | 0.05 | parts by mass |
| Surfactant F-9 shown below | 0.0018 | parts by mass |
| Water | 74.0 | parts by mass |
| Ethanol | 22.4 | parts by mass |

### Modified Polyvinyl Alcohol

(in the formula, the numerical value described in each repeating unit denotes the content (% by mass) of each repeating unit with respect to all repeating units; weight-average molecular 14,000)

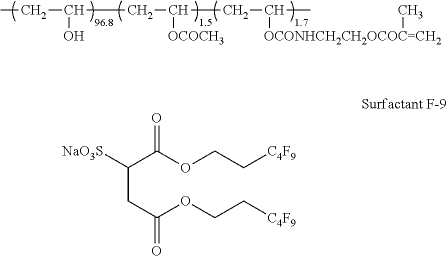

### Example 2

An absorptive polarizing film 2 was produced by the same method as in Example 1, except that the following composition C2 for forming a light absorption anisotropic film was used instead of the composition C1 for forming a light absorption anisotropic film, and the second heating step was set to 75° C.

Composition C2 for forming light absorption anisotropic film

| | | |
|---|---|---|
| Dichroic substance Dye-Y1 shown above | 0.018 | parts by mass |
| Dichroic substance Dye-M1 shown above | 0.11 | parts by mass |
| Dichroic substance Dye-C1 shown above | 0.11 | parts by mass |
| Dichroic substance Dye-C2 shown above | 0.34 | parts by mass |
| Liquid crystal compound L-1 shown above | 1.33 | parts by mass |
| Liquid crystal compound L-2 shown above | 0.57 | parts by mass |
| Adhesion improver A-1 shown above | 0.04 | parts by mass |
| Polymerization initiator IRGACURE | 0.07 | parts by mass |
| OXE-02 (manufactured by BASF) | | |
| Surfactant F-1 shown above | 0.006 | parts by mass |
| Cyclopentanone | 94.96 | parts by mass |
| Benzyl alcohol | 2.43 | parts by mass |

### Example 3

An absorptive polarizing film 3 was produced by the same method as in Example 1, except that the following composition C3 for forming a light absorption anisotropic film was used instead of the composition C1 for forming a light absorption anisotropic film, and the second heating step was set to 75° C.

Composition C3 for forming light absorption anisotropic film

| | | |
|---|---|---|
| Dichroic substance Dye-Y1 shown above | 0.019 | parts by mass |
| Dichroic substance Dye-M1 shown above | 0.12 | parts by mass |
| Dichroic substance Dye-C1 shown above | 0.12 | parts by mass |
| Dichroic substance Dye-C2 shown above | 0.37 | parts by mass |
| Liquid crystal compound L-1 shown above | 1.29 | parts by mass |
| Liquid crystal compound L-2 shown above | 0.55 | parts by mass |
| Adhesion improver A-1 shown above | 0.04 | parts by mass |
| Polymerization initiator IRGACURE | 0.07 | parts by mass |
| OXE-02 (manufactured by BASF) | | |
| Surfactant F-1 shown above | 0.006 | parts by mass |
| Cyclopentanone | 94.96 | parts by mass |
| Benzyl alcohol | 2.43 | parts by mass |

### Example 4

An absorptive polarizing film 4 was produced by the same method as in Example 1, except that the following composition C4 for forming a light absorption anisotropic film was used instead of the composition C1 for forming a light absorption anisotropic film, and the second heating step was set to 75° C.

Composition C4 for forming light absorption anisotropic film

| | | |
|---|---|---|
| Dichroic substance Dye-Y1 shown above | 0.013 | parts by mass |
| Dichroic substance Dye-M1 shown above | 0.08 | parts by mass |
| Dichroic substance Dye-C1 shown above | 0.08 | parts by mass |
| Dichroic substance Dye-C2 shown above | 0.25 | parts by mass |
| Liquid crystal compound L-1 shown above | 1.43 | parts by mass |
| Liquid crystal compound L-3 shown below | 0.61 | parts by mass |
| Adhesion improver A-1 shown above | 0.04 | parts by mass |
| Polymerization initiator IRGACURE | 0.08 | parts by mass |
| OXE-02 (manufactured by BASF) | | |
| Surfactant F-2 shown below | 0.007 | parts by mass |
| Cyclopentanone | 94.96 | parts by mass |
| Benzyl alcohol | 2.43 | parts by mass |

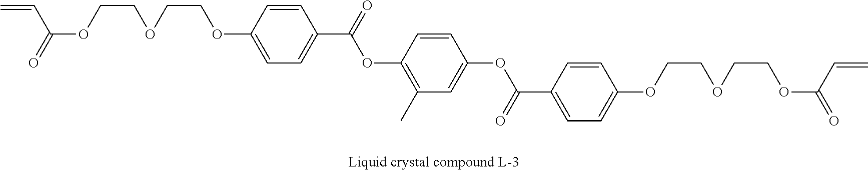 [SMILES: C=CC(=O)OCCOCCOc1ccc(C(=O)Oc2ccc(OC(=O)c3ccc(OCCOCCOC(=O)C=C)cc3)c(C)c2)cc1]

### Surfactant F-2

(in the formula, the numerical value described in each repeating unit denotes the content (% by mass) of each repeating unit with respect to all repeating units; Ac represents —C(O)CH₃;

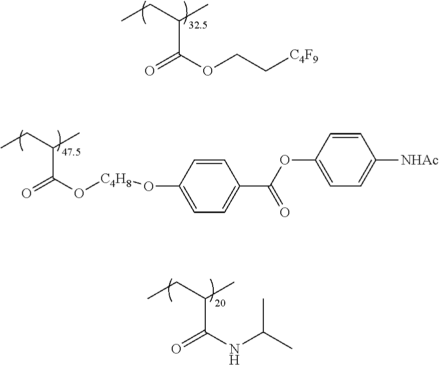

### Example 5

An absorptive polarizing film 5 was produced by the same method as in Example 1, except that the following composition C5 for forming a light absorption anisotropic film was used instead of the composition C1 for forming a light absorption anisotropic film, and the second heating step was set to 75° C.

Composition C5 for forming light absorption anisotropic film

| | | |
|---|---|---|
| Dichroic substance Dye-Y1 shown above | 0.018 | parts by mass |
| Dichroic substance Dye-M1 shown above | 0.11 | parts by mass |
| Dichroic substance Dye-C1 shown above | 0.11 | parts by mass |
| Dichroic substance Dye-C2 shown above | 0.34 | parts by mass |
| Liquid crystal compound L-1 shown above | 1.33 | parts by mass |
| Liquid crystal compound L-3 shown above | 0.57 | parts by mass |
| Adhesion improver A-1 shown above | 0.04 | parts by mass |
| Polymerization initiator IRGACURE | 0.07 | parts by mass |
| OXE-02 (manufactured by BASF) | | |
| Surfactant F-2 shown above | 0.006 | parts by mass |
| Cyclopentanone | 94.96 | parts by mass |
| Benzyl alcohol | 2.43 | parts by mass |

### Example 6

An absorptive polarizing film 6 was produced by the same method as in Example 1, except that the following composition C6 for forming a light absorption anisotropic film was used instead of the composition C1 for forming a light absorption anisotropic film, and the second heating step was set to 75° C.

Composition C6 for forming light absorption anisotropic film

| | | |
|---|---|---|
| Dichroic substance Dye-Y1 shown above | 0.019 | parts by mass |
| Dichroic substance Dye-M1 shown above | 0.12 | parts by mass |
| Dichroic substance Dye-C1 shown above | 0.12 | parts by mass |
| Dichroic substance Dye-C2 shown above | 0.37 | parts by mass |
| Liquid crystal compound L-1 shown above | 1.29 | parts by mass |
| Liquid crystal compound L-3 shown above | 0.55 | parts by mass |
| Adhesion improver A-1 shown above | 0.04 | parts by mass |
| Polymerization initiator IRGACURE | 0.07 | parts by mass |
| OXE-02 (manufactured by BASF) | | |
| Surfactant F-2 shown above | 0.006 | parts by mass |
| Cyclopentanone | 94.96 | parts by mass |
| Benzyl alcohol | 2.43 | parts by mass |

### Example 7

An absorptive polarizing film 7 was produced by the same method as in Example 1, except that the following composition C7 for forming a light absorption anisotropic film was used instead of the composition C1 for forming a light absorption anisotropic film, and the second heating step was set to 75° C.

Composition C7 for forming light absorption anisotropic film

| | | |
|---|---|---|
| Dichroic substance Dye-Y1 shown above | 0.013 | parts by mass |
| Dichroic substance Dye-M1 shown above | 0.08 | parts by mass |
| Dichroic substance Dye-C1 shown above | 0.08 | parts by mass |
| Dichroic substance Dye-C2 shown above | 0.25 | parts by mass |
| Liquid crystal compound L-1 shown above | 1.43 | parts by mass |
| Liquid crystal compound L-4 shown below | 0.61 | parts by mass |
| Adhesion improver A-1 shown above | 0.04 | parts by mass |
| Polymerization initiator IRGACURE | 0.08 | parts by mass |
| OXE-02 (manufactured by BASF) | | |
| Surfactant F-2 shown above | 0.007 | parts by mass |
| Cyclopentanone | 94.96 | parts by mass |
| Benzyl alcohol | 2.43 | parts by mass |

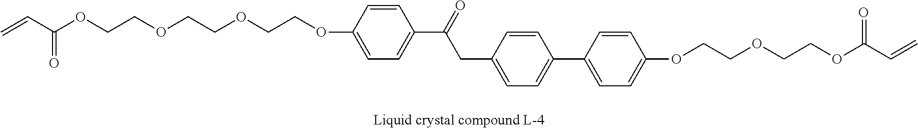 [SMILES: C=CC(=O)OCCOCCOCCOc1ccc(C(=O)Cc2ccc(-c3ccc(OCCOCCOC(=O)C=C)cc3)cc2)cc1]

### Example 8

An absorptive polarizing film 8 was produced by the same method as in Example 1, except that the following composition C8 for forming a light absorption anisotropic film was used instead of the composition C1 for forming a light absorption anisotropic film, and the second heating step was set to 75° C.

Composition C8 for forming light absorption anisotropic film

| | | |
|---|---|---|
| Dichroic substance Dye-Y1 shown above | 0.018 | parts by mass |
| Dichroic substance Dye-M1 shown above | 0.11 | parts by mass |
| Dichroic substance Dye-C1 shown above | 0.11 | parts by mass |
| Dichroic substance Dye-C2 shown above | 0.34 | parts by mass |
| Liquid crystal compound L-1 shown above | 1.33 | parts by mass |
| Liquid crystal compound L-4 shown above | 0.57 | parts by mass |
| Adhesion improver A-1 shown above | 0.04 | parts by mass |
| Polymerization initiator IRGACURE | 0.07 | parts by mass |
| OXE-02 (manufactured by BASF) | | |
| Surfactant F-2 shown above | 0.006 | parts by mass |
| Cyclopentanone | 94.96 | parts by mass |
| Benzyl alcohol | 2.43 | parts by mass |

### Example 9

An absorptive polarizing film 9 was produced by the same method as in Example 1, except that the following composition C9 for forming a light absorption anisotropic film was used instead of the composition C1 for forming a light absorption anisotropic film, and the second heating step was set to 75° C.

Composition C9 for forming light absorption anisotropic film

| | | |
|---|---|---|
| Dichroic substance Dye-Y1 shown above | 0.019 | parts by mass |
| Dichroic substance Dye-M1 shown above | 0.12 | parts by mass |
| Dichroic substance Dye-C1 shown above | 0.12 | parts by mass |
| Dichroic substance Dye-C2 shown above | 0.37 | parts by mass |
| Liquid crystal compound L-1 shown above | 1.29 | parts by mass |
| Liquid crystal compound L-4 shown above | 0.55 | parts by mass |
| Adhesion improver A-1 shown above | 0.04 | parts by mass |
| Polymerization initiator IRGACURE | 0.07 | parts by mass |
| OXE-02 (manufactured by BASF) | | |
| Surfactant F-2 shown above | 0.006 | parts by mass |
| Cyclopentanone | 94.96 | parts by mass |
| Benzyl alcohol | 2.43 | parts by mass |

### Example 10

An absorptive polarizing film 10 was produced by the same method as in Example 9, except that the second heating step was not performed.

### Example 11

An absorptive polarizing film 11 was produced by the same method as in Example 1, except that the following composition C11 for forming a light absorption anisotropic film was used instead of the composition C1 for forming a light absorption anisotropic film.

Composition C11 for forming light absorption anisotropic film

| | | |
|---|---|---|
| Dichroic substance Dye-Y1 shown above | 0.013 | parts by mass |
| Dichroic substance Dye-M1 shown above | 0.08 | parts by mass |
| Dichroic substance Dye-C1 shown above | 0.33 | parts by mass |
| Liquid crystal compound L-1 shown above | 1.43 | parts by mass |
| Liquid crystal compound L-2 shown above | 0.61 | parts by mass |
| Adhesion improver A-1 shown above | 0.04 | parts by mass |
| Polymerization initiator IRGACURE | 0.08 | parts by mass |
| OXE-02 (manufactured by BASF) | | |
| Surfactant F-1 shown above | 0.007 | parts by mass |
| Cyclopentanone | 94.96 | parts by mass |
| Benzyl alcohol | 2.43 | parts by mass |

### Comparative Example 1

An absorptive polarizing film H1 was produced by the same method as in Example 1, except that the second heating step was set to 75° C.

### Comparative Example 2

An absorptive polarizing film H2 was produced by the same method as in Example 5, except that the coating film was not irradiated with LED.

In a case where 100 arrangement structures of the dichroic substance present in a cross section of the light absorption anisotropic film observed with a scanning transmission electron microscope were selected for the light absorption anisotropic film used in the production of the absorptive polarizing films of Examples 1 to 11 and Comparative Examples 1 and 2, the number of arrangement structures in which the length of the major axis was less than 50 nm was calculated by the above-described method. The results are shown in Table 1 below. In the light absorption anisotropic film used in Example 10, since the associate was not formed, it is indicated as “-” in Table 1 below.

### [Production of Virtual Reality Display Apparatus]

### <Production of Retardation Layer Film 1 Including Positive A-Plate>

The above-described cellulose acylate film A1 was continuously coated with a coating liquid E1 for forming a photo-alignment film, having the following formulation, with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.2 μm, thereby obtaining a TAC film with the photo-alignment film.

Coating liquid E1 for forming photo-alignment film

| | | |
|---|---|---|
| Polymer PA-2 shown below | 100.00 | parts by mass |
| Thermal cationic polymerization | 5.00 | parts by mass |
| initiator PAG-1 shown above | | |
| Acid generator CPI-110TF shown below | 0.005 | parts by mass |
| Isopropyl alcohol | 16.50 | parts by mass |
| Butyl acetate | 1072.00 | parts by mass |
| Methyl ethyl ketone | 268.00 | parts by mass |

Polymer PA-2 [in the formula, the numerical value described in each repeating unit denotes the content (% by mass) of each repeating unit with respect to all repeating units; weight-average molecular weight: 45,000]

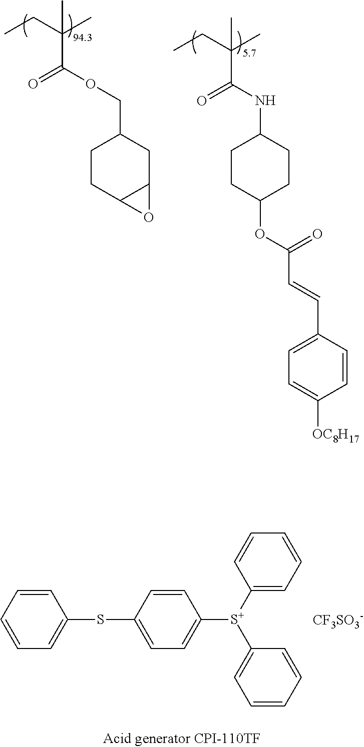

The above-described photo-alignment film E1 was coated with a composition F1 having the following formulation with a bar coater. The coating film formed on the photo-alignment film E1 was heated to 120° C. with hot air, cooled to 60° C., irradiated with ultraviolet rays having a wavelength of 365 nm with an illuminance of 100 mJ/cm² using a high-pressure mercury lamp in a nitrogen atmosphere, and continuously irradiated with ultraviolet rays with an illuminance of 500 mJ/cm² while being heated at 120° C., so that the alignment of the liquid crystal compound was immobilized, thereby producing a retardation layer 1 including a positive A-plate F1.

A thickness of the positive A-plate F1 was 2.5 μm, and an Re(550) was 144 nm. In addition, the positive A-plate satisfied a relationship of “Re(450)<Re(550)<Re(650)”. Re(450)/Re(550) was 0.82. The above-described positive A-plate corresponds to a so-called λ/4 plate.

Composition F1

| | | |
|---|---|---|
| Polymerizable liquid crystal compound | 43.50 | parts by mass |
| LA-1 shown below | | |
| Polymerizable liquid crystal compound | 43.50 | parts by mass |
| LA-2 shown below | | |
| Polymerizable liquid crystal compound | 8.00 | parts by mass |
| LA-3 shown below | | |
| Polymerizable liquid crystal compound | 5.00 | parts by mass |
| LA-4 shown below | | |
| Polymerization initiator PI-1 shown below | 0.55 | parts by mass |
| Leveling agent T-1 shown below | 0.20 | parts by mass |
| Cyclopentanone | 235.00 | parts by mass |

### Polymerizable Liquid Crystal Compound LA-1 (tBu Represents a Tertiary Butyl Group)

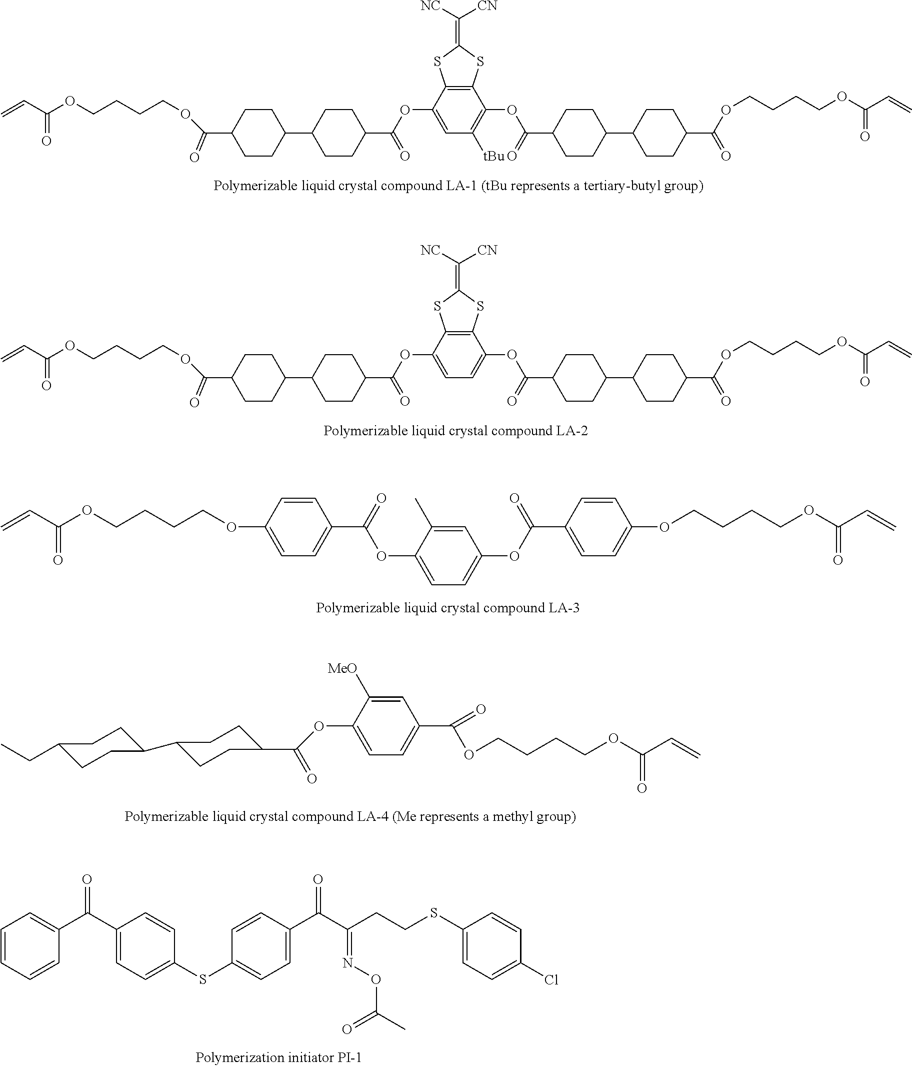

Leveling agent T-1 [in the formula, the numerical value described in each repeating unit denotes the content (% by mass) of each repeating unit with respect to all repeating units; weight-average molecular weight: 25,000]

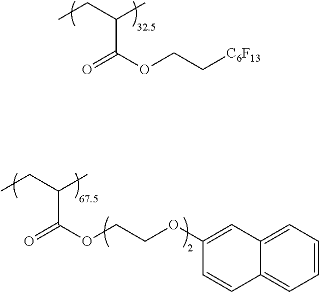

### <Production of Retardation Layer Film 2 Including Positive C-Plate>

The above-described cellulose acylate film A1 was used as a temporary support.

After passing the cellulose acylate film A1 through a dielectric heating roll at a temperature of 60° C. to raise the film surface temperature to 40° C., an alkaline solution having the formulation shown below was applied onto one surface of the film using a bar coater at a coating amount of 14 ml/m², followed by heating to 110° C., and transportation of the film under a steam type far-infrared heater manufactured by Noritake Company Limited for 10 seconds.

Next, the film was coated with pure water such that the coating amount reached 3 ml/m² using the same bar coater. Next, the film was washed with water by a fountain coater and drained by an air knife three times, and then transported to a drying zone at 70° C. for 10 seconds and dried to produce a cellulose acylate film A1 subjected to an alkali saponification treatment.

(Alkaline solution)

| | | |
|---|---|---|
| Potassium hydroxide | 4.7 | parts by mass |
| Water | 15.8 | parts by mass |
| Isopropanol | 63.7 | parts by mass |
| Fluorine-containing surfactant SF-1 | 1.0 | part by mass |
| (C₁₄H₂₉O(CH₂CH₂O)₂₀H) | | |
| Propylene glycol | 14.8 | parts by mass |

The cellulose acylate film A1 which had been subjected to the alkali saponification treatment was continuously coated with a coating liquid G1 for forming an alignment film, having the following formulation, using a #8 wire bar. The obtained film was dried with hot air at 60° C. for 60 seconds, and further dried with hot air at 100° C. for 120 seconds to form an alignment film G1.

Coating liquid G1 for forming alignment film

| | | |
|---|---|---|
| Polyvinyl alcohol (PVA103 | 2.4 | parts by mass |
| manufactured by Kuraray Co., Ltd.) | | |
| Isopropyl alcohol | 1.6 | parts by mass |
| Methanol | 36 | parts by mass |
| Water | 60 | parts by mass |

The alignment film G1 was coated with a coating liquid H1 for forming a positive C-plate, having the following formulation, the obtained coating film was aged at 60° C. for 60 seconds and irradiated with ultraviolet rays at an illuminance of 1000 mJ/cm² in the air using an air-cooled metal halide lamp at an illuminance of 70 mW/cm² (manufactured by Eye Graphics Co., Ltd.), and the alignment state thereof was fixed to vertically align the liquid crystal compound, thereby producing a retardation layer film 2 including a positive C-plate H1 with a thickness of 0.5 μm.

Rth(550) of the obtained positive C-plate was −60 nm.

Coating liquid H1 for forming positive C-plate

| | | |
|---|---|---|
| Liquid crystal compound LC-1 shown below | 80 | parts by mass |
| Liquid crystal compound LC-2 shown below | 20 | parts by mass |
| Vertically aligned liquid crystal compound | 1 | part by mass |
| S01 shown below | | |
| Ethylene oxide-modified trimethylolpropane | 8 | parts by mass |
| triacrylate (V#360, manufactured by | | |
| Organic Chemical Industry Ltd.) | | |
| IRGACURE 907 (manufactured by BASF SE) | 3 | parts by mass |
| KAYACURE DETX (manufactured by Nippon | 1 | part by mass |
| Kayaku Co., Ltd.) | | |
| Compound B03 shown below | 0.4 | parts by mass |
| Methyl ethyl ketone | 170 | parts by mass |
| Cyclohexanone | 30 | parts by mass |

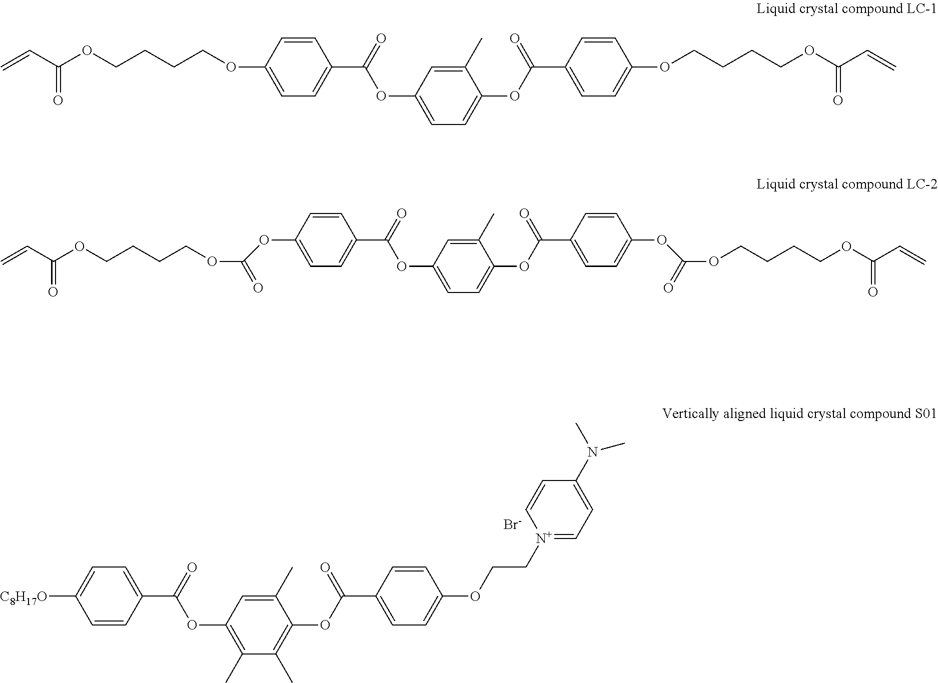

Compound B03 [in the formula, the numerical value described in each repeating unit denotes the content (% by mass) of each repeating unit with respect to all repeating units; weight-average molecular weight: 15,000]

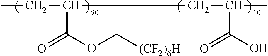

<Production of optical laminate B0>

An optical laminate B0 was produced by the following procedure. A wideband dielectric multi-layer film (trade name: APF, 3M Company) was used as a linear polarization-type reflective polarizer. The positive A-plate side of the obtained retardation layer film 1 was bonded to one surface of the APF, and the alignment layer and the support were peeled off. Furthermore, the alignment film was peeled off, the positive C-plate side of the obtained retardation layer film 2 was bonded to the exposed liquid crystal surface with a pressure sensitive adhesive, and the support and the alignment layer were peeled off. In this manner, an optical laminate B0 consisting of linear polarization-type reflective polarizer/pressure sensitive adhesive layer/positive A-plate/positive C-plate was produced.

### <Formation of Half Mirror Lens>

A convex surface side of a lens (convex meniscus lens LE1076-A (diameter: 2 inches) manufactured by Thorlabs, Inc.) was subjected to aluminum vapor deposition to form a half mirror so that the reflectivity was 40%, thereby forming a half mirror lens composed of the lens and the half mirror.

<Production of absorptive polarizer film 1MK5>

The protective layer side of the absorptive polarizer film 1 produced in Example 1 was bonded to the PMMA film through a pressure sensitive adhesive sheet, only the support was peeled off to obtain an absorptive polarizer film 1M, and the absorptive polarizer film 1M was set in a forming device. At this time, the PMMA film side was positioned on the lower side. The forming space in the forming device consisted of a box 1 and a box 2 partitioned by the absorptive polarizer film 1M, and a mold 1 (convex lens having a diameter of 2 inches and a curvature radius of 84 mm) was disposed in the box 1 located below the absorptive polarizer film 1M such that the convex surface (forming surface) was on the upper side. In addition, a transparent window was installed on the upper portion of the box 2 above the absorptive polarizer film 1M, and an IR light source for heating the absorptive polarizer film 1M was installed outside the window. Next, each of the inside of the box 1 and the inside of the box 2 was evacuated to 0.1 atm or less by a vacuum pump. Next, as a step of heating the absorptive polarizer film 1M, the absorptive polarizer film 1M was irradiated with infrared rays and heated until the temperature of the absorptive polarizer film 1M reached 108° C. Since a glass transition temperature Tg of the PMMA film used as the support was 105° C., the film was in a state of being easily stretched during the forming. Next, as a step of pressing the absorptive polarizer film 1M against the mold 1 to deform the absorptive polarizer film 1M along a shape of the mold 1, gas was allowed to flow into the box 2 from a gas cylinder to pressurize the absorptive polarizer film 1M to 300 kPa, and the absorptive polarizer film 1M was pressed against the mold 1. Finally, the absorptive polarizer film 1M was removed from the lens which was the mold 1. In this manner, an absorptive polarizer film 1M formed into a non-planar shape was obtained.

Next, the absorptive polarizer film 1M formed into a non-planar shape was set in the forming device such that the PMMA film side was located on the upper side, with the first forming being performed in the opposite direction. In this case, a region of the absorptive polarizer film 1M, which was formed into a non-planar shape by the first forming, protruded on the lower side. A meniscus lens (diameter: 2 inches, curvature radius of concave side: 70 mm) on which aluminum was vapor-deposited on the convex side as the mold 2 was disposed immediately below the region formed into the non-planar shape in the absorptive polarizer film 1M such that the concave surface was on the upper side. Next, each of the inside of the box 1 and the inside of the box 2 was evacuated to 0.1 atm or less by a vacuum pump. Next, as a step of heating the absorptive polarizer film 1M, the absorptive polarizer film 1M was irradiated with infrared rays and heated until the temperature of the absorptive polarizer film 1M reached 108° C. Next, as a step of pressing the absorptive polarizer film 1M against the mold 2 to deform the absorptive polarizer film 1M along a shape of the mold 2, gas was allowed to flow into the box 2 from a gas cylinder to pressurize the absorptive polarizer film 1M to 300 kPa, and the absorptive polarizer film 1M was pressed against the mold 2. Finally, the absorptive polarizer film 1M was removed from the lens which was the mold 2. In this manner, an absorptive polarizer film 1MK5 formed into a curved surface was obtained by the forming method 1.

<Production of optical laminate B0K5>

The optical laminate B0 was set in a forming device. In this case, the positive C-plate side was disposed to be on the lower side. Thereafter, an optical laminate B0K5 formed into a non-planar shape was obtained in the same manner as in the method for producing the absorptive polarizer film 1MK5.

<Production of optical laminate B1K5>

The APF (linear polarization-type reflective polarizer) side of the optical laminate BOKS obtained above and the photo-alignment film side of the absorptive polarizer film 1MK5 were bonded to each other with a pressure sensitive adhesive. However, the APF and the light absorption anisotropic film were laminated such that the transmission axis of the APF and the transmission axis of the light absorption anisotropic film matched each other. In this manner, an optical laminate B1K5 consisting of positive C-plate/positive A-plate/pressure sensitive adhesive layer/APF/pressure sensitive adhesive layer/absorptive polarizer was produced.

### <Production of Composite Lens>

The half mirror lens produced above was adjusted to the lens diameter and the curvature radius of the mold 2 in the same manner as the method for producing the absorptive polarizer film 1MK5, and was formed into a non-planar shape.

Next, the produced optical laminate B1K5 was bonded to the concave surface side of the half mirror lens formed into a non-planar shape with a pressure sensitive adhesive to obtain a composite lens.

A composite lens was obtained by the same method as described above, except that the absorptive polarizer films produced in Examples 2 to 11 and Comparative Examples 1 and 2 were used instead of the absorptive polarizer film 1.

### <Production of Virtual Reality Display Apparatus>

A virtual reality display apparatus “Huawei VR Glass” manufactured by Huawei Technologies Co., Ltd., which was a virtual reality display apparatus for which a reciprocating optical system was employed, was disassembled, and all composite lenses were taken out.

Instead of the extracted composite lens, the composite lens produced above was incorporated into the main body, and the virtual reality display apparatus was produced by further installing the composite lens such that the light absorption anisotropic film side in the composite lens was on the eye side. In the produced virtual reality display apparatus, a black-and-white checkered pattern was displayed on an image display panel, and ghost visibility was visually evaluated according to the following standard. The results are shown in Table 1 below.

### (Evaluation for Ghost)

AA: ghost was almost invisible.
A: ghost was slightly visible, but not noticeable.
B: ghost was slightly visible, but not noticeable.
C: weak ghost was visible.
D: slightly strong ghost was visible.

TABLE 1

| | | | Dichroic substance | | | | | | |
|---|---|---|---|---|---|---|---|---|---|
| | Liquid | | | Number of | | | | | |
| | crystal compound | | | arrangement | | | | | |
| | Liquid | | | structures | | | | | |
| | crystal | | | in which | | | | | |
| | compound | | | length of | Process | | | | |
| | having | Largest | | major axis | Temperature | | | | |
| | largest | LogP | Content | is less than | in second | Evaluation | | | |
| | LogP value | value | (mg/cm³) | 50 nm | heating step | ΔT1 (%) | ΔT2 (%) | ΔE1 | Ghost |
| Example 1 | RA | 7.21 | 170 | 5 | 100° C. | 1.59 | 2.0 | 1.8 | B |
| Example 2 | RA | 7.21 | 230 | 38 | 75° C. | 1.75 | 2.4 | 2.0 | B |
| Example 3 | RA | 7.21 | 250 | 27 | 75° C. | 1.21 | 1.3 | 1.5 | A |
| Example 4 | L-3 | 4.23 | 170 | 51 | 75° C. | 1.5 | 1.8 | 1.7 | B |
| Example 5 | L-3 | 4.23 | 230 | 36 | 75° C. | 1.1 | 1.4 | 1.4 | A |
| Example 6 | L-3 | 4.23 | 250 | 25 | 75° C. | 0.5 | 0.4 | 1.0 | AA |
| Example 7 | L-4 | 4.15 | 170 | 52 | 75° C. | 1.5 | 2.1 | 1.7 | B |
| Example 8 | L-4 | 4.15 | 230 | 37 | 75° C. | 1.2 | 1.2 | 1.4 | A |
| Example 9 | L-4 | 4.15 | 250 | 24 | 75° C. | 0.5 | 0.4 | 0.9 | AA |
| Example 10 | L-4 | 4.15 | 250 | — | None | 2.1 | 2.7 | 2.1 | C |
| Example 11 | RA | 7.21 | 170 | 3 | 100° C. | 1.6 | 1.8 | 1.8 | B |
| Comparative | RA | 7.21 | 170 | 55 | 75° C. | 3.5 | 4.5 | 3.2 | D |
| Example 1 | | | | | | | | | |
| Comparative | L-3 | 4.23 | 230 | 36 | 75° C. | 6.8 | 9.2 | 5.8 | D |
| Example 2 | | | | | | | | | |

As shown in Table 1, it was found that, in a case where the absolute value (ΔT₁) of the difference between the transmittance T₁₁ and the transmittance T₁₂ was more than 2.5%, ghosts occurred in a case of being applied to the pancake lens-type virtual reality display apparatus (Comparative Examples 1 and 2).

On the other hand, it was found that, in a case where the absolute value (ΔT₁) of the difference between the transmittance T₁₁ and the transmittance T₁₂ was 2.5% or less, the occurrence of ghosts was suppressed in a case of being applied to the pancake lens-type virtual reality display apparatus (Examples 1 to 11).

In addition, from the comparison between Examples 5 and 6 and the comparison between Examples 8 to 10, it was found that, in a case where 100 arrangement structures of the dichroic substance present in the cross section of the light absorption anisotropic film observed with a scanning transmission electron microscope were selected, as the number of arrangement structures in which the length of the major axis was less than 50 nm was 30 or less, the occurrence of ghosts could be further suppressed in a case of being applied to the pancake lens-type virtual reality display apparatus.

In addition, from the comparison between Example 4 and Example 5 and the comparison between Example 7 and Example 8, it was found that, in a case where the content of the dichroic substance was 230 mg/cm³ or more, the occurrence of ghosts could be further suppressed in a case of being applied to the pancake lens-type virtual reality display apparatus.

In addition, from the comparison between Example 2 and Example 5 and the comparison between Example 3 and Example 6, it was found that, in a case where the light absorption anisotropic film was a film obtained by fixing the alignment state of the liquid crystal composition containing the liquid crystal compound and the LogP value of the liquid crystal compound was 6 or less, the occurrence of ghosts could be further suppressed in a case of being applied to the pancake lens-type virtual reality display apparatus.

### EXPLANATION OF REFERENCES

1: maximum projection image
2: circle X
3: circle Y
4: centroid
10: light absorption anisotropic film
Z: any four points on circle Y
20: forming die having concave forming surface
22: film
24: film on which concave surface shape is transferred
26: forming die having convex forming surface
28: film on which convex surface shape is transferred
50A, 50B: laminate
54: retardation layer having function of converting linearly polarized light into circularly polarized light
56: positive C-plate
58: cholesteric liquid crystal layer
60: linear polarization-type reflective polarizer
70: composite lens
72, 90: laminate
74, 88: lens
76, 86: half mirror
80: virtual reality display apparatus
82: image display apparatus
84: circularly polarizing plate
92: ray

What is claimed is:

1. A light absorption anisotropic film having a curved surface portion,
wherein a transmittance measured by the following procedure satisfies the following expression (1),
the procedure:
1: the light absorption anisotropic film is orthographically projected to specify a maximum projection image having a maximum area,
2: a circle X having a minimum area, including all maximum projection images of the light absorption anisotropic film, is drawn as a circle having a center at a centroid of the maximum projection image of the light absorption anisotropic film,
3: a circle Y having a radius of ½ of a radius of the circle X is drawn as a circle having a center at the centroid of the maximum projection image of the light absorption anisotropic film,
4: a transmittance T₁₁ at an intersection G between a line which passes through the centroid of the maximum projection image of the light absorption anisotropic film and extends in a normal direction of the maximum projection image and the light absorption anisotropic film is measured,
5: transmittances are measured at each intersection between each line which passes through any four points on the circle Y and extends in the normal direction of the maximum projection image and the light absorption anisotropic film, and among these transmittances, a transmittance T₁₂ at which an absolute value of a difference with the transmittance T₁₁ is maximum is specified; where a point at which the transmittance T₁₂ in the light absorption anisotropic film is measured is denoted by an intersection A,
$$\begin{matrix}the expression ( 1 ) & \\ Δ {T}_{1} = \vert {T}_{11} - {T}_{12} \vert \leq 2.5 \% . & \end{matrix}$$

2. The light absorption anisotropic film according to claim 1,
wherein, with regard to the transmittance at the intersection G, in a case where a transmittance before heating at 120° C. for 10 minutes is denoted by T₂₁ and a transmittance after the heating is denoted by T₂₂, the following expression (2) is satisfied,
$$\begin{matrix}the expression ( 2 ) & \\ Δ {T}_{2} = \vert {T}_{21} - {T}_{22} \vert \leq 3. \% . & \end{matrix}$$

3. The light absorption anisotropic film according to claim 1,
wherein, in a case where a brightness at the intersection G is denoted by L₁₁* and a chromaticity is denoted by a₁₁* and b₁₁*, and a brightness at the intersection A is denoted by L₁₂* and a chromaticity is denoted by a₁₂* and biz*, the following expression (3) is satisfied,
$$Δ {E}_{1} = \sqrt{{( {L}_{11}^{*} - {L}_{12}^{*} )}^{2} + {( {a}_{11}^{*} - + {a}_{12}^{*} )}^{2} + {( {b}_{11}^{*} - {b}_{12}^{*} )}^{2}} ≦ 3. \qquad ( 3 )$$

4. The light absorption anisotropic film according to claim 1,
wherein the light absorption anisotropic film contains a dichroic substance.

5. The light absorption anisotropic film according to claim 4,
wherein at least a part of the dichroic substance forms an arrangement structure.

6. The light absorption anisotropic film according to claim 5,
wherein, in a case where 100 arrangement structures present in a cross section of the light absorption anisotropic film observed with a scanning transmission electron microscope are selected, the number of arrangement structures in which a length of a major axis is less than 50 nm is 30 or less.

7. The light absorption anisotropic film according to claim 4,
wherein a content of the dichroic substance is 230 mg/cm³ or more.

8. The light absorption anisotropic film according to claim 1,
wherein the light absorption anisotropic film is a film obtained by fixing an alignment state of a liquid crystal composition containing a liquid crystal compound, and
a LogP value of the liquid crystal compound is 6 or less,
provided that, in a case where the liquid crystal composition contains a plurality of kinds of liquid crystal compounds, the LogP value of the liquid crystal compound refers to a largest LogP value among LogP values of the plurality of kinds of liquid crystal compounds.

9. A laminate comprising:
the light absorption anisotropic film according to claim 1.

10. The laminate according to claim 9,
wherein the laminate includes the light absorption anisotropic film, a retardation layer, and a reflective polarizer layer.

11. A composite lens comprising, in the following order:
the laminate according to claim 9;
a lens; and
a half mirror.

12. A virtual reality display apparatus comprising:
the laminate according to claim 9.

13. The light absorption anisotropic film according to claim 2,
wherein, in a case where a brightness at the intersection G is denoted by L₁₁* and a chromaticity is denoted by a₁₁* and bᵢᵢ*, and a brightness at the intersection A is denoted by L₁₂* and a chromaticity is denoted by a₁₂* and biz*, the following expression (3) is satisfied,
$$Δ {E}_{1} = \sqrt{{( {L}_{11}^{*} - {L}_{12}^{*} )}^{2} + {( {a}_{11}^{*} - + {a}_{12}^{*} )}^{2} + {( {b}_{11}^{*} - {b}_{12}^{*} )}^{2}} ≦ 3. \qquad ( 3 )$$

14. The light absorption anisotropic film according to claim 2,
wherein the light absorption anisotropic film contains a dichroic substance.

15. The light absorption anisotropic film according to claim 14,
wherein at least a part of the dichroic substance forms an arrangement structure.

16. The light absorption anisotropic film according to claim 15,
wherein, in a case where 100 arrangement structures present in a cross section of the light absorption anisotropic film observed with a scanning transmission electron microscope are selected, the number of arrangement structures in which a length of a major axis is less than 50 nm is 30 or less.

17. The light absorption anisotropic film according to claim 5,
wherein a content of the dichroic substance is 230 mg/cm³ or more.

18. The light absorption anisotropic film according to claim 2,
wherein the light absorption anisotropic film is a film obtained by fixing an alignment state of a liquid crystal composition containing a liquid crystal compound, and
a LogP value of the liquid crystal compound is 6 or less,
provided that, in a case where the liquid crystal composition contains a plurality of kinds of liquid crystal compounds, the LogP value of the liquid crystal compound refers to a largest LogP value among LogP values of the plurality of kinds of liquid crystal compounds.

19. A laminate comprising:
the light absorption anisotropic film according to claim 2.

20. The laminate according to claim 19,
wherein the laminate includes the light absorption anisotropic film, a retardation layer, and a reflective polarizer layer.
